(19) United States
(12) Patent Application Publication
(10) Pub. No.: US 2023/0179337 A1
(43) Pub. Date: Jun. 8, 2023

(54) HYBRID AUTOMATIC REPEAT REQUEST (HARQ) FEEDBACK OPERATION WITH SIDELINK UNLICENSED

(71) Applicant: QUALCOMM Incorporated, San Diego, CA (US)

(72) Inventors: Qing Li, Princeton Junction, NJ (US); Junyi Li, Fairless Hills, PA (US); Hong Cheng, Basking Ridge, NJ (US); Ozcan Ozturk, San Diego, CA (US); Shuanshuan Wu, San Diego, CA (US)

(21) Appl. No.: 18/049,122

(22) Filed: Oct. 24, 2022

Related U.S. Application Data
(60) Provisional application No. 63/265,026, filed on Dec. 6, 2021.

(51) Int. Cl. H04L 1/18; H04L 5/00; H04W 72/08; H04W 16/14; H04W 74/08

(52) U.S. Cl. CPC H04L 1/1812; H04L 5/0055; H04W 72/087; H04W 16/14; H04W 74/0808

(57) ABSTRACT

Systems, methods, and devices for wireless communication that support mechanisms for sidelink feedback reporting over an unlicensed spectrum in a wireless communication system. In aspects, a transmitting UE monitors for a feedback response for a sidelink transmission from one or more receiving UEs at each feedback occasion of a sidelink feedback window. A receiving UE attempts to transmit the feedback response by performing a listen-before-talk (LBT) procedure at each feedback occasion of the sidelink feedback window. In aspects, the sidelink feedback window may be defined as a plurality of sidelink feedback occasions, or may be defined as a duration of an LBT timer covering a plurality of sidelink feedback occasions. The receiving UE stops attempting to transmit the feedback response once the receiving UE successfully performs an LBT procedure at a feedback occasion, and the transmitting UE stops monitoring for a feedback response a feedback response is successfully received.

### CROSS-REFERENCE TO RELATED APPLICATIONS

This application claims the benefit of U.S. Provisional Patent Application No. 63/265,026, entitled, “HYBRID AUTOMATIC REPEAT REQUEST (HARQ) FEEDBACK OPERATION WITH SIDELINK UNLICENSED,” filed on Dec. 6, 2021, which is expressly incorporated by reference herein in its entirety.

### TECHNICAL FIELD

Aspects of the present disclosure relate generally to wireless communication systems, and more particularly, to sidelink feedback reporting in an unlicensed spectrum.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication performed by a user equipment (UE) includes transmitting a sidelink transmission to another UE, starting monitoring for a feedback response for the sidelink transmission from the another UE at each occasion of a plurality of feedback occasions covered by a sidelink feedback window, detecting a triggering condition associated with a feedback occasion of the plurality of feedback occasions, and, in response to detecting the triggering condition associated with a feedback occasion of the plurality of feedback occasions, starting a sidelink feedback timer and stopping monitoring for the feedback response at each occasion of the plurality of feedback occasions.

In an additional aspect of the disclosure, a method of wireless communication performed by a UE includes receiving a sidelink transmission from another UE, starting performing a listen-before-talk (LBT) procedure sequentially at each occasion of a plurality of feedback occasions covered by a sidelink feedback window to transmit a feedback response for the sidelink transmission, detecting a triggering condition associated with a feedback occasion of the plurality of feedback occasions, and, in response to detecting the triggering condition associated with a feedback occasion of the plurality of feedback occasions, starting a sidelink feedback timer and stopping performing the LBT procedure sequentially at each occasion of a plurality of feedback occasions.

In an additional aspect of the disclosure, a UE includes at least one processor and a memory coupled to the at least one processor. The at least one processor stores processor-readable code that, when executed by the at least one processor, is configured to perform operations including transmitting a sidelink transmission to another UE, starting monitoring for a feedback response for the sidelink transmission from the another UE at each occasion of a plurality of feedback occasions covered by a sidelink feedback window, detecting a triggering condition associated with a feedback occasion of the plurality of feedback occasions, and, in response to detecting the triggering condition associated with a feedback occasion of the plurality of feedback occasions, starting a sidelink feedback timer and stopping monitoring for the feedback response at each occasion of the plurality of feedback occasions.

In an additional aspect of the disclosure, a UE includes at least one processor and a memory coupled to the at least one processor. The at least one processor stores processor-readable code that, when executed by the at least one processor, is configured to perform operations including receiving a sidelink transmission from another UE, starting performing an LBT procedure sequentially at each occasion of a plurality of feedback occasions covered by a sidelink feedback window to transmit a feedback response for the sidelink transmission, detecting a triggering condition associated with a feedback occasion of the plurality of feedback occasions, and, in response to detecting the triggering condition associated with a feedback occasion of the plurality of feedback occasions, starting a sidelink feedback timer and stopping performing the LBT procedure sequentially at each occasion of a plurality of feedback occasions.

In an additional aspect of the disclosure, a non-transitory computer-readable medium stores instructions that, when executed by a processor, cause the processor to perform operations. The operations include transmitting a sidelink transmission to another UE, starting monitoring for a feedback response for the sidelink transmission from the another UE at each occasion of a plurality of feedback occasions covered by a sidelink feedback window, detecting a triggering condition associated with a feedback occasion of the plurality of feedback occasions, and, in response to detecting the triggering condition associated with a feedback occasion of the plurality of feedback occasions, starting a sidelink feedback timer and stopping monitoring for the feedback response at each occasion of the plurality of feedback occasions.

In an additional aspect of the disclosure, a non-transitory computer-readable medium stores instructions that, when executed by a processor, cause the processor to perform operations. The operations include receiving a sidelink transmission from another UE, starting performing an LBT procedure sequentially at each occasion of a plurality of feedback occasions covered by a sidelink feedback window to transmit a feedback response for the sidelink transmission, detecting a triggering condition associated with a feedback occasion of the plurality of feedback occasions, and, in response to detecting the triggering condition associated with a feedback occasion of the plurality of feedback occasions, starting a sidelink feedback timer and stopping performing the LBT procedure sequentially at each occasion of a plurality of feedback occasions.

In an additional aspect of the disclosure, an apparatus includes means for transmitting a sidelink transmission to another UE, means for starting monitoring for a feedback response for the sidelink transmission from the another UE at each occasion of a plurality of feedback occasions covered by a sidelink feedback window, means for detecting a triggering condition associated with a feedback occasion of the plurality of feedback occasions, and means for, in response to detecting the triggering condition associated with a feedback occasion of the plurality of feedback occasions, starting a sidelink feedback timer and stopping monitoring for the feedback response at each occasion of the plurality of feedback occasions.

In an additional aspect of the disclosure, an apparatus includes means for receiving a sidelink transmission from another UE, means for starting performing an LBT procedure sequentially at each occasion of a plurality of feedback occasions covered by a sidelink feedback window to transmit a feedback response for the sidelink transmission, means for detecting a triggering condition associated with a feedback occasion of the plurality of feedback occasions, and means for, in response to detecting the triggering condition associated with a feedback occasion of the plurality of feedback occasions, starting a sidelink feedback timer and stopping performing the LBT procedure sequentially at each occasion of a plurality of feedback occasions.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIG. 3 is a block diagram illustrating examples of feedback message configuration in sidelink implementations.

FIG. 4 is a block diagram of an example wireless communications system that supports mechanisms for sidelink feedback reporting over an unlicensed spectrum in a wireless communication system according to one or more aspects.

FIG. 5 is a timing diagram illustrating an example of a sidelink feedback configuration in accordance with aspects of the present disclosure.

FIG. 6 is a timing diagram illustrating an example process that supports mechanisms for sidelink feedback reporting over an unlicensed spectrum in a wireless communication system according to one or more aspects

FIG. 7 is a flow diagram illustrating an example process that supports mechanisms for sidelink feedback reporting over an unlicensed spectrum according to one or more aspects.

FIG. 8 is a flow diagram illustrating an example process that supports mechanisms for sidelink feedback reporting over an unlicensed spectrum according to one or more aspects.

FIG. 9 is a block diagram of an example UE that supports mechanisms for sidelink feedback reporting over an unlicensed spectrum according to one or more aspects.

The Appendix provides further details regarding various aspects of this disclosure and the subject matter therein forms a part of the specification of this application.

Like reference numbers and designations in the various drawings indicate like elements.

### DETAILED DESCRIPTION

The detailed description set forth below, in connection with the appended drawings and appendix, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Particular implementations of the subject matter described in this disclosure may be implemented to realize one or more of the following potential advantages or benefits. In some aspects, the present disclosure provides techniques for.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜0.99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “mmW” band.

The frequencies between FR1 and FR2 are often referred to as mid-band frequencies. Recent 5G NR studies have identified an operating band for these mid-band frequencies as frequency range designation FR3 (7.126 GHz-24.25 GHz). Frequency bands falling within FR3 may inherit FR1 characteristics and/or FR2 characteristics, and, thus, may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2x (52.6 GHz-71 GHz), FR4 (71 GHz-114.25 GHz), and FR5 (114.25 GHz-275 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmW” or the like if used herein may broadly represent frequencies that may include mid-band frequencies, may be within FR2, FR2x, FR4, and/or FR5, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmW transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmW components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

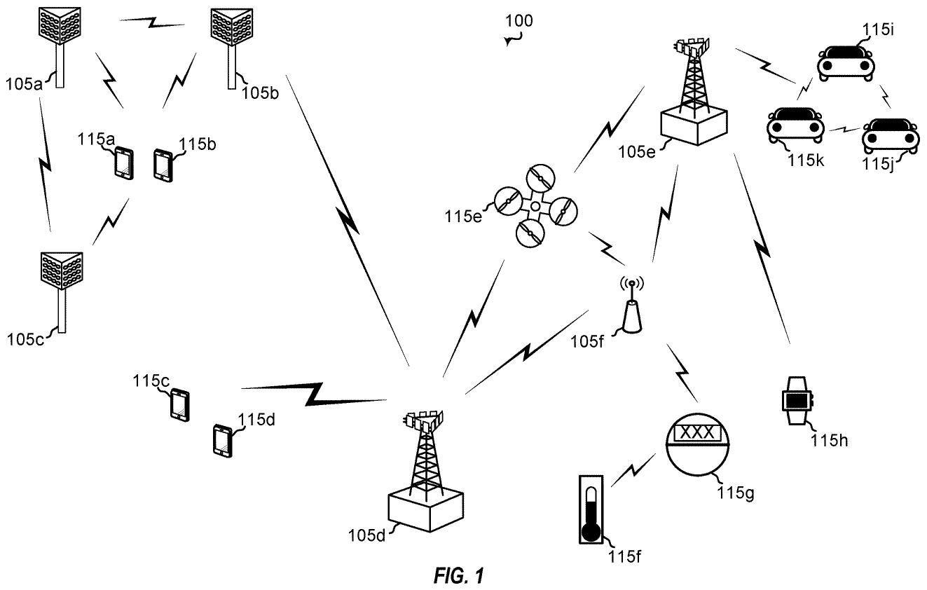

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

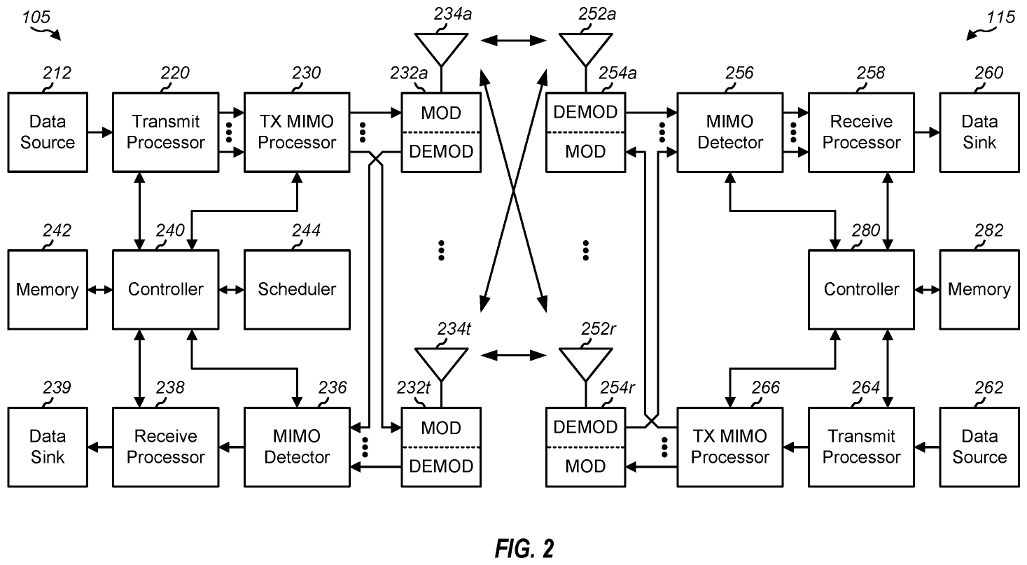

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

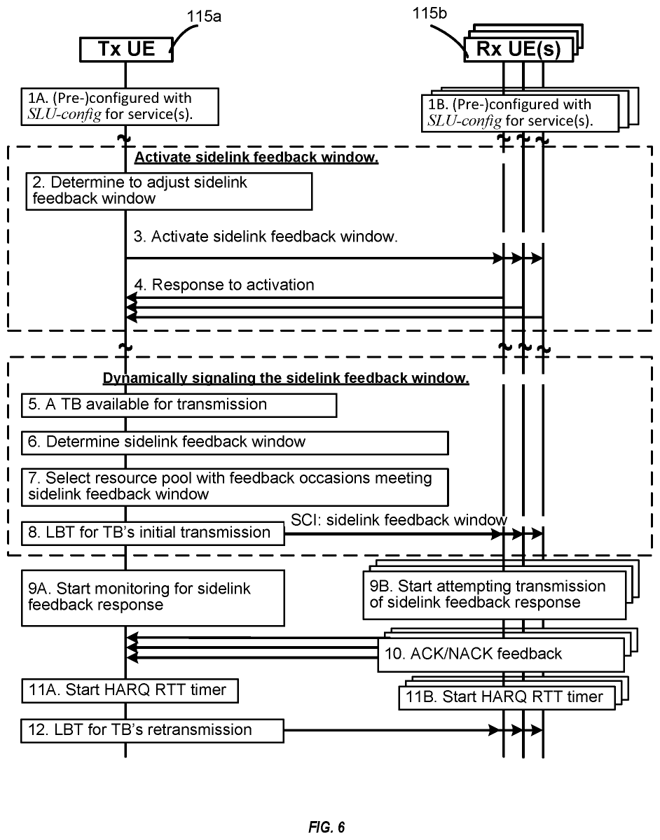

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 6-8, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, a 16-μs, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

Sensing for shared channel access may also be categorized into either full-blown or abbreviated types of LBT procedures. For example, a full LBT procedure, such as a CAT 3 or CAT 4 LBT procedure, including extended channel clearance assessment (ECCA) over a non-trivial number of 9-μs slots, may also be referred to as a “Type 1 LBT.” An abbreviated LBT procedure, such as a CAT 2 LBT procedure, which may include a one-shot CCA for 16-μs or 25-μs, may also be referred to as a “Type 2 LBT.”

Use of a medium-sensing procedure to contend for access to an unlicensed shared spectrum may result in communication inefficiencies. This may be particularly evident when multiple network operating entities (e.g., network operators) are attempting to access a shared resource. In wireless communications system 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

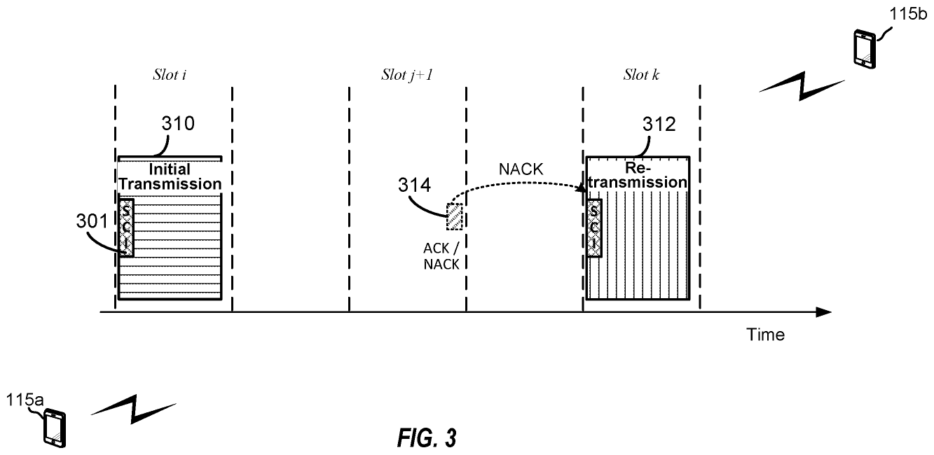

In current wireless communication systems, feedback operations (e.g., hybrid automatic repeat request (HARQ) feedback) over a sidelink may be implemented in which a feedback message may be configured to indicate to a transmitting UE that a sidelink transmission was successfully received or not by one or more receiving UEs. When the feedback message indicates that the sidelink transmission was not successfully received by the one or more receiving UE, the transmitting UE may retransmit the sidelink transmission. On the other hand, when the feedback message indicates that the sidelink transmission was successfully received by the one or more receiving UEs, the transmitting UE may know that the sidelink transmission does not need to be retransmitted. FIG. 3 is a block diagram illustrating examples of feedback message configuration in sidelink implementations.

As shown in FIG. 3, transmitting UE 115a may transmit sidelink transmission 310 at slot i. In implementations, sidelink transmission 310 may include sidelink control information (SCI) 301 including control and configuration information that a receiving UE (e.g., receiving UE 115b) may use to decode sidelink transmission 310. Receiving UE 115b may either successfully receive sidelink transmission 310 (e.g., may successfully receive and decode SCI 301 associated with sidelink transmission 310, and/or may successfully receive and decode sidelink transmission 310) or may not successfully receive sidelink transmission 310 (e.g., may fail to either receive and/or decode SCI 301 associated with sidelink transmission 310, and/or may fail to either receive and/or decode sidelink transmission 310). Receiving UE 115b may transmit feedback message 314 to transmitting UE 115a at slot j+1 indicating whether sidelink transmission 310 was successfully received by receiving UE 115b or not, and transmitting UE 115a may determine whether to retransmit the sidelink transmission at slot k based on feedback message 314. Receiving UE 115b may transmit, in response to successfully receiving sidelink transmission 310 from transmitting UE 115a, feedback message 314 indicating that the sidelink transmission was successfully received. The feedback message indicating that the sidelink transmission was successfully received may be a positive acknowledgement (ACK) message. Transmitting UE 115a may receive the ACK message from receiving UE 115b and may determine that sidelink transmission 310 does not need to be retransmitted at slot k based on the ACK received in feedback message 314. As a result, transmitting UE 115a may not retransmit at slot k. On the other hand, receiving UE 115b may transmit, in response to a failure to receive sidelink transmission 310 from transmitting UE 115a, feedback message 314 indicating that the sidelink transmission was not successfully received. The feedback message indicating that the sidelink transmission was not successfully received may be a negative ACK (NACK) message. Transmitting UE 115a may receive the NACK message in feedback message 314 from receiving UE 115b and may know that sidelink transmission 310 was not successfully received by the receiving UE and may decide to retransmit sidelink transmission 310 to receiving UE 115b at slot k. As a result, transmitting UE 115a may be triggered to retransmit sidelink transmission 310 (e.g., as sidelink retransmission 312) at slot k.

In another situation, receiving UE 115b may intend to transmit either an ACK or a NACK to transmitting UE 115a in feedback message 314 at slot j+1, but receiving UE 115b may not win access to the transmission medium due to a listen-before-talk (LBT) failure, in which case receiving UE 115b may not be able to transmit the ACK or NACK to the transmitting UE. In these cases, transmitting UE may not receive feedback message 314 at slot j+1. Depending on the sidelink feedback implementation, this situation may create some problems. For example, there are currently various sidelink feedback implementations.

In sidelink feedback operations for unicast, transmitting UE 115a may transmit sidelink transmission 310 specifically to receiving UE 115b. In this case, receiving UE 115b may transmit either an ACK or a NACK in feedback message 314, respectively depending on whether sidelink transmission 310 is successfully received or not, and transmitting UE 115a may retransmit based on feedback message 314 as discussed above. In sidelink feedback operations for a managed groupcast, receiving UE 115b may be a member of a managed group of receiving UEs, and in which the members of the group may be known to transmitting UE 115a. In these cases, transmitting UE 115a may transmit sidelink transmission 310 to the group of receiving UEs including receiving UE 115b. In these cases, transmitting UE 115a may expect to receive a feedback message (e.g., an ACK or NACK) from each member of the group. For any member for which an ACK is not received, transmitting UE 115a may determine to retransmit sidelink transmission 310 to that member. For example, where an ACK is not received from receiving UE 115b (e.g., a NACK is received from receiving UE 115b, or no feedback message is received from receiving UE 115b), transmitting UE 115a may determine to retransmit sidelink transmission 310 (e.g., as sidelink retransmission 312) at slot k to receiving UE 115b.

In sidelink feedback operations for unicast and managed groupcast, a problem may arise when a receiving UE may not be able to transmit a feedback message (e.g., an ACK or NACK) such as due to an LBT failure by the receiving UE, as mentioned above. For example, receiving UE 115b may attempt to transmit an ACK in feedback message 314 to transmitting UE 115a, but receiving UE 115b may not win access to the transmission medium due to an LBT failure, in which case receiving UE 115b may not be able to transmit the ACK in feedback message 314 to transmitting UE 115a. As a result of not receiving the ACK, transmitting UE 115a may retransmit sidelink message 310 to receiving UE 115b in slot k, which may cause an unnecessary retransmission in slot k, lowering resource utilization.

In sidelink feedback operations for a connectionless groupcast, receiving UE 115b may be a member of a group of receiving UEs that may not be a managed group of receiving UEs, and transmitting UE 115a may not know which receiving UEs are members of the group. In these cases, transmitting UE 115a may transmit sidelink transmission 310 to the group of receiving UEs. In a manner, these connectionless groupcast implementations are akin to broadcast transmissions. In these cases, transmitting UE 115a may not expect a feedback message from all members of the group. Instead, transmitting UE 115a may retransmit sidelink transmission 310 when a NACK is received in feedback message 314 from any of the members of the group. In this case, transmitting UE 115a may retransmit sidelink transmission 310 as sidelink retransmission 312 at slot k to all members of the group of receiving UEs in response to receiving at least one NACK from at least one receiving UE. Otherwise, if no NACK is received by transmitting UE 115a, transmitting UE 115a may not perform a retransmission of the sidelink transmission at slot k. In this manner, no NACK is considered an ACK. In these implementations, it is possible that receiving UE 115b, as a member of the group of receiving UEs, may fail to receive the sidelink transmission and may attempt to transmit a NACK to transmitting UE 115a at slot j+1, but the NACK may not be received by transmitting UE 115a (e.g., the NACK may be lost during transmission or may not be decoded properly by the transmitting UE). In another case, receiving UE 115b may not be able to transmit a NACK to transmitting UE 115a due to an LBT failure by receiving UE 115b, as mentioned above. As a result, transmitting UE 115a may not receive the NACK message in feedback message 314 at slot j+1. In this case, transmitting UE 115a may not retransmit sidelink message 310 as sidelink retransmission 312 at slot k, which may degrade performance.

Various aspects of the present disclosure are directed to systems and methods that support mechanisms for sidelink feedback reporting over an unlicensed spectrum in a wireless communication system. In aspects, a transmitting UE may transmit a sidelink transmission to one or more receiving UEs. The transmitting UE and the one or more receiving UEs may be configured to enable feedback reporting for the sidelink transmission in accordance with aspects of the present disclosure. For example, the transmitting UE may be configured with a sidelink feedback window over which the transmitting UE may monitor for a feedback response from the one or more receiving UEs for the sidelink transmission. From a receiving UE perspective (e.g., a receiving UE of the one or more receiving UEs), a receiving UE may be configured with the sidelink feedback window over which the receiving UE may attempt to transmit a feedback response for the sidelink transmission to the transmitting UE. In aspects, the sidelink feedback window may be defined as a plurality of sidelink feedback occasions, or may be defined as a duration of an LBT timer covering a plurality of sidelink feedback occasions. In aspects, the receiving UE may stop attempting to transmit the feedback response for the sidelink transmission to the transmitting UE once the receiving UE successfully performs an LBT procedure for a sidelink feedback occasion within the sidelink feedback window and transmits the sidelink feedback to the transmitting UE, or once the receiving UE reaches the last sidelink feedback occasion of the plurality of sidelink feedback occasions without LBT procedure success. The transmitting UE may stop monitoring for a feedback response from the one or more receiving UEs for the sidelink transmission once the transmitting UE successfully receives a feedback response from the one or more receiving UEs, or once the transmitting UE reaches the last sidelink feedback occasion of the plurality of sidelink feedback occasions without receiving a feedback response from the one or more receiving UEs. In aspects, the transmitting UE may retransmit the sidelink transmission to the one or more receiving UEs in response to receiving a NACK message, or in response to reaching the last sidelink feedback occasion of the plurality of sidelink feedback occasions without receiving a feedback response from the one or more receiving UEs when the transmitting UE is configured for automatic retransmission (e.g., configured to retransmit the sidelink retransmission if no feedback response is received).

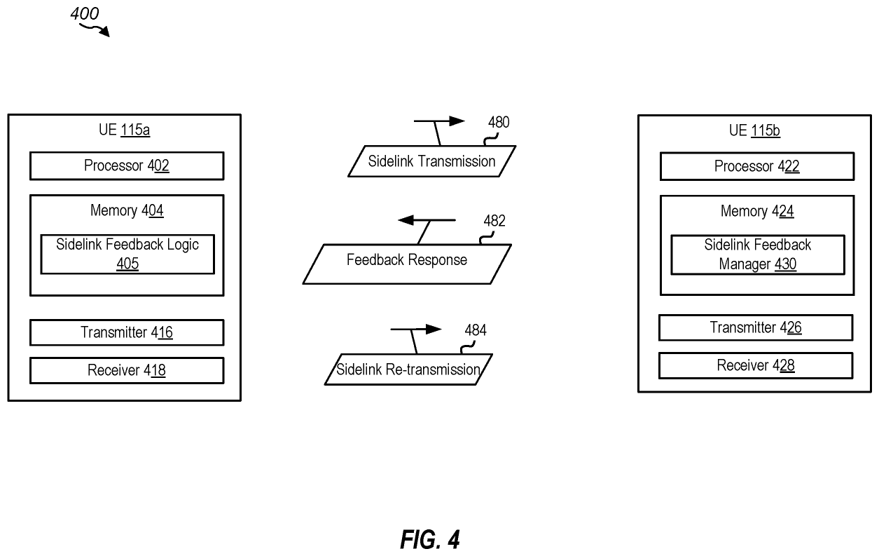

FIG. 4 is a block diagram of an example wireless communications system 400 that supports mechanisms for sidelink feedback reporting over an unlicensed spectrum in a wireless communication system according to one or more aspects. In some examples, wireless communications system 400 may implement aspects of wireless network 100. Wireless communications system 400 includes UE 115a and UE 115b. In aspects, UE 115a and UE 115b may be configured to communicate with each other over a sidelink. In the discussion that follows, UE 115a may be described as a transmitting UE and UE 115b may be described as a receiving UE, and in this context transmitting UE 115a may transmit sidelink transmissions (e.g., sidelink transmission 480) to receiving UE 115b, and receiving UE 115b may transmit feedback response (e.g., feedback response 482) for the sidelink transmissions to transmitting UE 115a. It is noted that receiving UE 115b may be one of one or more receiving UEs to which sidelink transmission 480 is transmitted from transmitting UE 115a. However, this description of UE 115a as a transmitting UE and UE 115b as receiving UE, as well as the description of system 400 as including two sidelink UEs, is merely for illustrative purposes and not intended to be limiting in any way. As such, wireless communications system 400 may generally include multiple UEs 115, and may include more one or more base stations (not shown), such as base station 105.

UE 115a may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), and one or more receivers 418 (hereinafter referred to collectively as “receiver 418”). Processor 402 may be configured to execute instructions stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store sidelink feedback logic 405. In aspects, sidelink feedback logic 405 may be configured to perform operations for determining a sidelink feedback window for monitoring for a sidelink feedback response from receiving UE 115b, monitoring for the sidelink feedback response from receiving UE 115b over the sidelink feedback window, and/or determining when to stop monitoring for the sidelink feedback response from receiving UE 115b over the sidelink feedback window in accordance with aspects of the present disclosure.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105. In some implementations, transmitter 416 and receiver 418 may be integrated in one or more transceivers. Additionally or alternatively, transmitter 416 or receiver 418 may include or correspond to one or more components of UE 115 described with reference to FIG. 2.

UE 115b also may include a variety of components (such as structural, hardware components) used for carrying out one or more functions described herein. For example, these components may include one or more processors 422 (hereinafter referred to collectively as “processor 422”), one or more memory devices 424 (hereinafter referred to collectively as “memory 424”), one or more transmitters 426 (hereinafter referred to collectively as “transmitter 426”), and one or more receivers 428 (hereinafter referred to collectively as “receiver 428”). Processor 422 may be configured to execute instructions stored in memory 424 to perform the operations described herein. In some implementations, processor 422 includes or corresponds to one or more of receive processor 258, transmit processor 264, and controller 280, and memory 424 includes or corresponds to memory 282.

Memory 424 includes or is configured to store sidelink feedback manager 430. In aspects, sidelink feedback manager 430 may be configured to perform operations for determining a sidelink feedback window for attempting to transmit a sidelink feedback response to transmitting UE 115a at each sidelink feedback occasion covered by the sidelink feedback window depending on an LBT procedure, for and/or determining when to stop attempting to transmit the sidelink feedback response to transmitting UE 115a in accordance with aspects of the present disclosure.

Transmitter 426 is configured to transmit reference signals, control information and data to one or more other devices, and receiver 428 is configured to receive references signals, synchronization signals, control information and data from one or more other devices. For example, transmitter 426 may transmit signaling, control information and data to, and receiver 428 may receive signaling, control information and data from, base station 105. In some implementations, transmitter 426 and receiver 428 may be integrated in one or more transceivers. Additionally or alternatively, transmitter 426 or receiver 428 may include or correspond to one or more components of UE 115 described with reference to FIG. 2.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP.

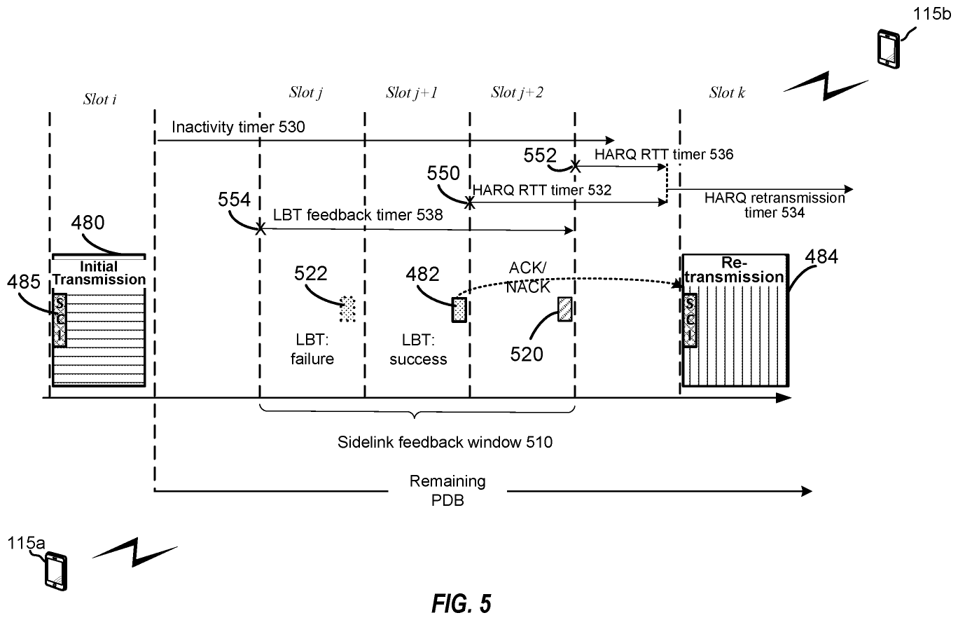

In the following discussion, operations of wireless communication system 400 will be discussed with additional reference to FIG. 5. FIG. 5 is a timing diagram illustrating an example of a sidelink feedback configuration in accordance with aspects of the present disclosure. In the discussion that follows, operations of the one or more receiving UEs are described with reference to receiving UE 115b. However, it should be noted that the operations described with reference to receiving UE 115b are equally applicable to any of the one or more receiving UEs, and the description with respect to receiving UE 115b is for illustrative purposes and not by way of limitations.

During operation of wireless communication system 400, transmitting UE 115a transmits sidelink transmission 480 to one or more receiving UEs including receiving UE 115b at slot i. For example, transmitting UE 115a may perform an LBT procedure to gain access to the spectrum medium at slot i. Upon a successful LBT procedure, transmitting UE 115a may transmit sidelink transmission 480 to the one or more receiving UEs at slot i. In aspects, sidelink transmission 480 may include SCI that may be used by the one or more receiving UEs to decode sidelink transmission 480. As noted above, transmitting UE 115a and the one or more receiving UEs may be configured to enable sidelink feedback reporting for sidelink transmission 480. In aspects, the sidelink feedback reporting may include configuration of a sidelink feedback window (e.g., sidelink feedback window 510). From transmitting UE 115a's perspective, sidelink feedback window 510 may include a window over which transmitting UE 115a may monitor for a sidelink feedback response for sidelink transmission 480 from the one or more receiving UEs. From the one or more receiving UEs' perspective, for example from receiving UE 115b's perspective, sidelink feedback window 510 may include a window over which receiving UE 115b may attempt to transmit (e.g., may perform LBT to transmit)) a sidelink feedback response for sidelink transmission 480 to transmitting UE 115a.

During operation of wireless communication system 400, transmitting UE 115a starts monitoring, in response to transmitting sidelink transmission 480 to the one or more receiving UEs, for a sidelink feedback response for sidelink transmission 480 over sidelink feedback window 510. On receiving UE 115b side, receiving UE 115b, in response to receiving sidelink transmission 480, may prepare sidelink feedback response 482 for sidelink transmission 480 (e.g., an ACK or a NACK depending on whether sidelink transmission 480 was successfully received or decoded by receiving UE 115b or not) and may start attempting to transmit sidelink feedback response 482 to transmitting UE 115a over sidelink feedback window 510.

In aspects, the configuration of sidelink feedback window 510 may define sidelink feedback window 510 as a number of sidelink feedback occasions, which may be distributed over a number of slots in accordance with feedback resource allocation. For example, sidelink feedback window 510 may be configured as a number of sidelink feedback occasions. For example, sidelink feedback occasions 522, 482 and 520 may be evenly distributed in slots j, j+1, and j+2, as shown in FIG. 5, in accordance with feedback resources being allocated in each slot in a resource pool. As such, in this non-limiting example, sidelink feedback window 510 may include three slots, namely slots j, j+1, and j+2. In this case, transmitting UE 115a may monitor for a sidelink feedback response at each feedback occasion in slots j, j+1, and j+2, and receiving UE 115b may conduct LBT-based sidelink feedback reporting at each feedback occasion in slots j, j+1, and j+2. In another example (not shown), sidelink feedback occasions 522, 482 and 520 may be evenly distributed in slots j, j+2, and j+4 (not shown) in accordance with feedback resources being allocated in every two slots in a resource pool. As such, in this non-limiting example, sidelink feedback window 510 may include 5 slots, namely slots j, j+1, j+2, j+3, and j+4. In this case, transmitting UE 115a may monitor for a sidelink feedback response at each feedback occasion in slots j, j+2, and j+4, and receiving UE 115b may conduct LBT-based sidelink feedback reporting at each feedback occasion in slots j, j+2, and j+4.

In alternative or additional aspects, the configuration of sidelink feedback window 510 may define sidelink feedback window 510 as a duration of an LBT feedback timer. For example, sidelink feedback window 510 may be configured as a duration of LBT feedback timer 538, which in this example covers slots j, j+1, and j+2. As such, in this non-limiting example, sidelink feedback window 510 may include three slots, namely slots j, j+1, and j+2. For example, the feedback window 510 with the duration of slots j, j+1, and j+2 may contain 3 feedback occasions, e.g., feedback occasions 522, 482 and 520 (as shown in FIG. 5), in accordance with feedback resources being allocated in each slot in a resource pool. In another example, sidelink feedback window 510 may include a duration covering slots j, j+1, and j+2, which may contain 2 feedback occasions, e.g., feedback occasion 522 in Slot j and feedback occasion 482 in Slot j+2 (not shown in FIG. 5), such as in accordance with feedback resources being allocated in every two slots for a resource pool. In either example above, as sidelink feedback window 510 covers slots j, j+1, and j+2, transmitting UE 115a and receiving UE 115b may monitor for a sidelink feedback response and may conduct LBT-based sidelink feedback, respectively, at feedback occasions within sidelink feedback window 510 over slots j, j+1, and j+2, e.g., at feedback occasions at slots j, j+1, and j+2 or at slots j, and j+2 based on the feedback resource allocation in a resource pool.

As exemplified above, sidelink feedback window 510 may be bounded to the number of feedback occasions with variable time durations based on the feedback resource allocation configured in different resource pools, when configured with a number of feedback occasions. In this manner, such a configuration may be more suitable for meeting high reliability requirements with a number of feedback occasions. In the case where sidelink feedback window 510 may be bounded to a time duration with variable number of feedback occasions based on the feedback resource allocations in different resource pools, when configured with an LBT feedback timer, such a configuration may be more suitable for meeting low latency requirement with a time duration.

In aspects, sidelink feedback window 510 may be configured, activated, and/or dynamically signaled to transmitting UE 115a and/or receiving UE 115b.

For example, in implementations where sidelink feedback window 510 is defined as a number of sidelink feedback occasions, transmitting UE 115a and/or receiving UE 115b may be configured and/or pre-configured with a sidelink unlicensed (SLU) configuration. The SLU configuration (e.g., SLU_config) may be received by transmitting UE 115a and/or receiving UE 115b in a configuration message, and may include an indication of one or more numbers of sidelink feedback occasions (e.g., indicated in a N_HARQ_occasions parameter). In aspects, the one or more numbers of sidelink feedback occasions may be stored in transmitting UE 115a and/or receiving UE 115b. In some aspects, the one or more numbers of sidelink feedback occasions that may be pre-configured or configured with the SLU configuration may be based on QoS requirements, sidelink channel access priority class (SL CAPC) values and/or sidelink conditions. QoS requirements may include different performance requirements (e.g., different reliabilities, latencies, priorities, data volumes, etc. associated with different QoS profiles or PC5 5G QoS identifier (PQI) values) related to different services or communications (e.g., different destination IDs or link IDs or a pair of source and destination IDs associated with different sidelink services or applications such as V2X service types or ProSe identifiers) provided over the sidelink. SL CAPC may include parameters for priority based sidelink channel accessing on shared spectrum using LBT procedure, for example, related to a service or communication over the sidelink. Sidelink conditions may include current sidelink conditions between transmitting UE 115a and receiving UE 115b determined based on measurements including channel busy rate (CBR) measurements, sidelink reference signal received power (RSRP) or received signal strength indicator (RSSI) measurements, an LBT success rate, a UE consistent LBT failure value, etc.

In implementations where sidelink feedback window 510 is defined as a duration of an LBT feedback timer, the SLU configuration received by transmitting UE 115a and/or receiving UE 115b may include an indication of one or more durations for the LBT feedback timer (e.g., indicated in a HARQ_feedback_timer parameter). In some aspects, the one or more durations for the LBT feedback timer may be stored in transmitting UE 115a and/or receiving UE 115b, and may be based on QoS requirements, sidelink channel access priority class (SL CAPC) and/or sidelink conditions. QoS requirements may include reliabilities (e.g., resource types, packet error rates, etc.), latencies (e.g., packet delay budgets (PDBs)), priorities (e.g., priority levels), data volumes (e.g., maximum data burst volumes, PC5 flow bit rates, PC5 link aggregated bit rates), etc. associated with QoS profiles or PC5 5G QoS identifier (PQI) values related to different services or communications provided over the sidelink. SL CAPC may include different sidelink channel access priority classes defined or specified for priority based sidelink channel accessing on shared spectrum, for example, related to different services or communications provided over the sidelink. Sidelink conditions may include current sidelink conditions between transmitting UE 115a and receiving UE 115b determined based on measurements including CBR measurements, sidelink RSRP or RSSI measurements, an LBT success rate, a UE consistent LBT failure value, etc.

In aspects, reconfiguring or activating a configuration for sidelink feedback window 510 may include transmitting UE 115a determining to adjust the configuration of sidelink feedback window 510 (e.g. pre-configured or configured with the SLU configuration) and reconfiguring or activating the adjustment. In aspects, transmitting UE 115a may reconfigure the configuration of sidelink feedback window 510 at receiving UE 115b using a radio resource control (RRC) command via the PC5, and/or may activate the adjusted configuration of sidelink feedback window 510 at receiving UE 115b using a medium access (MAC)-control element (CE) via the PC5 or via an SCI message to receiving UE 115b. In aspects, receiving UE 115b may respond to the reconfiguration or activation message with a confirmation message (e.g., PC5 RRC message or an ACK message associated with the activation message) to transmitting UE 115a. In this manner, the configuration of sidelink window 510 may be reconfigured or activated. In aspects, such as where sidelink feedback window 510 is defined as a number of sidelink feedback occasions, transmitting UE 115a may determine to adjust the configuration of sidelink feedback window 510 by determining to adjust the number of sidelink feedback occasions in sidelink feedback window 510. In these aspects, the adjusted number of sidelink feedback occasions determined by transmitting UE 115a may be based on QoS requirements, SL CAPC and/or sidelink conditions, as discussed above. In other aspects, such as where sidelink feedback window 510 is defined as a duration of an LBT feedback timer, transmitting UE 115a may determine to adjust the configuration of sidelink feedback window 510 by determining to adjust the one or more durations for the LBT feedback timer. In these aspects, the adjusted one or more durations for the LBT feedback timer determined by transmitting UE 115a may be based on QoS requirements, SL CAPC and/or sidelink conditions, as discussed above.

In aspects, dynamically signaling a configuration for sidelink feedback window 510 may include transmitting UE 115a, in response to determining that a transmission block (TB) is available for transmission (e.g., to be transmitted as sidelink transmission 480), and determining a configuration for sidelink feedback window 510 based on QoS requirements or SL CAPC associated with the TB and/or a sidelink condition determined based, at least in part, on sidelink measurements. In some aspects, the QoS requirements associated with the TB may include one or more of a priority level of the TB transmission, a reliability requirement for the TB transmission, a data volume of the TB, a maximum data rate for the TB, a packet delay budget (PDB) or remaining PDB. In some aspects, the SL CAPC associated with the TB may include one or more of channel access priority classes for the TB transmission. In some aspects, the sidelink measurements for determining the sidelink condition may include CBR measurements, sidelink RSRP or RSSI measurements, an LBT success rate, a UE consistent LBT failure value, etc. In aspects, transmitting UE 115a may select a resource pool including a plurality of sidelink feedback occasions meeting the determined configuration for sidelink feedback window 510. For example, in aspects where sidelink feedback window 510 is defined as a number of sidelink feedback occasions, transmitting UE 115a may select a resource pool that includes a number of sidelink feedback occasions that meets the number of sidelink feedback occasions determined based on the QoS requirements or SL CAPC associated with the TB (e.g., determining a number of sidelink feedback occasions to meet reliability requirement, for example, and/or selecting a higher number of sidelink feedback occasions for high reliability) and/or the sidelink condition (e.g., determining a number of sidelink feedback occasions based on the CBR or RSRP or RSSI measurement, for example, selecting a smaller number of sidelink feedback occasions to ease channel congestion when CBR or RSRP or RSSI measurement is above a threshold; or determining a number of sidelink feedback occasions based on the LBT success rate or the UE consistent LBT failure value, for example, selecting a larger number of sidelink feedback occasions to increase channel accessing probability when the LBT success rate is below a threshold or when the UE consistent LBT failure value is above a threshold.). In aspects where sidelink feedback window 510 is defined as a duration of an LBT feedback timer, transmitting UE 115a may select a resource pool that includes a plurality of sidelink feedback occasions within a duration for LBT feedback timer 538 determined based on the QoS requirements or SL CAPC associated with the TB (e.g., determining a duration of LBT feedback timer to meet latency requirement such as PDB, for example, and/or selecting a duration based on PDB or remaining PDB) and/or the sidelink condition (e.g., determining a duration of LBT feedback timer based on the CBR or RSRP or RSSI measurement, for example, selecting a larger duration for high priority TB if CBR or RSRP or RSSI is above a threshold). In aspects, transmitting UE 115a may signal the configuration for sidelink feedback window 510 determined based on QoS requirements or SL CAPC associated with the TB and/or a sidelink condition to the one or more receiving UEs (including receiving UE 115b) in the SCI included in sidelink transmission 480. In this manner, sidelink feedback window 510 is dynamically signaled to the receiving UEs, for example, indicated in the SCI part 2 with one or more sidelink feedback occasions or a duration for LBT feedback timer.

In aspects, transmitting UE 115a starts monitoring for a sidelink feedback response for sidelink transmission 480 over sidelink feedback window 510 by starting monitoring, in response to transmitting sidelink transmission 480, for the sidelink feedback response over one of the feedback occasions of sidelink feedback window 510. For example, transmitting UE 115a may monitor for a sidelink feedback response for sidelink transmission 480 to be received over one of slots j, j+1, or j+2, as illustrated in FIG. 5.

In aspects where sidelink feedback window 510 is defined as a number of sidelink feedback occasions, transmitting UE 115a may stay active to monitor for the sidelink feedback response over sidelink feedback window 510 by starting or restarting inactivity timer 530, such that the duration of inactivity timer 530 covers at least the number of sidelink feedback occasions within sidelink feedback window 510, at the slot (e.g., slot i+1) after transmitting sidelink transmission 480 with a successful LBT to the one or more receiving UEs (including receiving UE 115b) at slot i. For example, as shown in FIG. 5, transmitting UE 115a may start or restart inactivity timer 530 to an active duration that includes at least slots j, j+1, or j+2. It is noted that in some aspects, the number of sidelink feedback occasions of sidelink feedback window 510 includes a number of sidelink feedback occasions that may be preconfigured, configured, activated, and/or dynamically signaled (e.g., dynamically indicated in the SCI transmitted with the sidelink transmission 480), as described above. In any case, transmitting UE 115a may start or restart inactivity timer 530, based in part at least on the sidelink feedback occasions that may be preconfigured, configured, activated, and/or dynamically signaled (e.g., dynamically indicated in the SCI transmitted with the sidelink transmission 480), to cover at least the number of sidelink feedback occasions of sidelink feedback window 510, namely slots j, j+1, or j+2, and may start monitoring for the sidelink feedback response over each of slots j, j+1, or j+2, while the inactivity timer is running.

In aspects where sidelink feedback window 510 is defined as a duration of an LBT feedback timer, transmitting UE 115a may monitor for the sidelink feedback response over sidelink feedback window 510 by starting LBT feedback timer 538, such that the duration of LBT feedback timer 538 covers at least the sidelink feedback occasions of sidelink feedback window 510. For example, as shown in FIG. 5, LBT feedback timer 538 may be set to run for a duration that covers at least slots j, j+1, or j+2. It is noted that in some aspects, the duration of LBT feedback timer 538 includes a duration that may be preconfigured, activated, and/or dynamically signaled (e.g., dynamically indicated in the SCI transmitted with the sidelink transmission 480), as described above. In any case, transmitting UE 115a may set the duration of LBT feedback timer 538, based in part at least on the duration of LBT feedback timer 538 that may be preconfigured, configured, activated, and/or dynamically signaled (e.g., dynamically indicated in the SCI transmitted with the sidelink transmission 480), to cover at least the sidelink feedback occasions of sidelink feedback window 510, namely slots j, j+1, or j+2, and may start monitoring for the sidelink feedback response over each of slots j, j+1, or j+2. In some aspects, inactivity timer 530, which may be started or restarted in the slot (e.g., at slot i+1) after transmitting sidelink transmission 480 in slot i to the one or more receiving UEs (including receiving UE 115b), may be stopped at time 550 after receiving at least a NACK transmission from one of the one or more receiving UEs (including receiving UE 115b), or may be stopped at time 554 when LBT feedback timer 538 is started at the beginning of sidelink feedback window 510, namely slots j. In alternative or additional aspects, inactivity timer 530 may not be used, such as when LBT feedback timer 538 is started in the slot (e.g., in slot i+1) after transmitting sidelink transmission 480 in slot i to the one or more receiving UEs (including receiving UE 115b).

In aspects, one or more receiving UE (e.g., receiving UE 115b) may receive sidelink transmission 480 including SCI 485. One or more receiving UE (e.g., receiving UE 115b) may attempt to decode sidelink transmission 480 based on the information in SCI 485. One or more receiving UE (e.g., receiving UE 115b) may prepare a feedback response to be transmitted to transmitting UE 115a dependent on whether the receiving UE (e.g., UE 115b) is able to successfully decode sidelink transmission 480. When receiving UE 115b is not able to successfully decode sidelink transmission 480 or fails to decide sidelink transmission 480, receiving UE 115b may generate a NACK response. When receiving UE 115b is able to successfully decode sidelink transmission 480, receiving UE 115b may generate an ACK response (e.g., in unicast and/or managed groupcast implementations)., or in some implementations may not send a feedback response back to transmitting UE 115a (e.g., in connectionless groupcast implementations where NACK is transmitted with failed decoding of sidelink transmission 480). In any case, receiving UE 115b may generate the sidelink feedback response to be transmitted to transmitting UE 115a over sidelink feedback window 510.

In aspects, receiving UE 115b starts attempting to transmit sidelink feedback response to transmitting UE 115a over sidelink feedback window 510, by performing, sequentially, an LBT procedure for each sidelink feedback occasion covered by sidelink feedback window 510. For example, in aspects where sidelink feedback window 510 is defined as a number of sidelink feedback occasions, receiving UE 115b may stay active for attempting to transmit sidelink feedback response to transmitting UE 115a by starting or restarting inactivity timer 530, based in part at least on the sidelink feedback occasions that may be preconfigured, configured, activated, and/or dynamically signaled (e.g., dynamically indicated in the SCI received with the sidelink transmission 480), such that the duration of inactivity timer 530 covers at least the number of sidelink feedback occasions of sidelink feedback window 510, at the slot after receiving sidelink transmission 480. In these aspects, receiving UE 115b may attempt to transmit sidelink feedback response at each sidelink feedback occasion of sidelink feedback window 510 while inactivity timer 530 is running. In aspects where sidelink feedback window 510 is defined as a duration of an LBT feedback timer, receiving UE 115b may start attempting to transmit sidelink feedback response to transmitting UE 115a by starting LBT feedback timer 538, based in part at least on the duration of LBT feedback timer 538 that may be preconfigured, configured, activated, and/or dynamically signaled (e.g., dynamically indicated in the SCI received with the sidelink transmission 480), such that the duration of LBT feedback timer 538 covers at least the sidelink feedback occasions of sidelink feedback window 510. In these aspects, receiving UE 115b may attempt to transmit sidelink feedback response at each sidelink feedback occasion of sidelink feedback window 510 while LBT feedback timer 538 is running. In some aspects, inactivity timer 530, which may be started or restarted at the slot after receiving sidelink transmission 480 from the transmitting UE 115a, may be stopped at time 550 after transmitting an ACK or NACK transmission to transmitting UE 115a, or may be stopped at time 554 when LBT feedback timer 538 is started at the beginning of sidelink feedback window 510, namely slots j. In alternative or additional aspects, inactivity timer 530 may not be used, such as when LBT feedback timer 538 is started in the slot after receiving sidelink transmission 480 from the transmitting UE 115a.

In aspects, receiving UE 115b may continue to perform the LBT procedure for each sidelink feedback occasion (e.g., feedback occasion 522, 482, or 520) until the LBT procedure is successful. Receiving UE 115b may transmit sidelink feedback response to transmitting UE 115a in a sidelink feedback occasion 482 for which the LBT procedure is successful. For example, receiving UE 115b may attempt to transmit sidelink feedback response to transmitting UE 115a at feedback occasion 522 in slot j of sidelink feedback window 510. To that end, receiving UE 115b may perform an LBT procedure to gain access to the unlicensed spectrum at feedback occasion 522 in slot j to transmit to transmitting UE 115a. In this example, the LBT procedure at feedback occasion 522 in slot j may fail. As such, receiving UE 115b may not be able to transmit sidelink feedback response to transmitting UE 115a in slot j. However, receiving UE 115b may continue attempting to transmit sidelink feedback response to transmitting UE 115a at feedback occasion 482 in slot j+1 of sidelink feedback window 510. To that end, receiving UE 115b may perform an LBT procedure to gain access to the unlicensed spectrum at feedback occasion 482 in slot j+1. In this example, the LBT procedure at feedback occasion 482 in slot j+1 may succeed. As a result, receiving UE 115b may transmit sidelink feedback response, including either an ACK or a NACK, as described above, to transmitting UE 115a.

On transmitter UE 115a's side, transmitting UE 115a may continue monitoring for a sidelink feedback response for sidelink transmission 480 over sidelink feedback window 510. As such, transmitting UE 115a may monitor for a sidelink feedback response for sidelink transmission 480 at feedback occasion 522 in slot j, but as receiving UE 115b was unable to transmit sidelink feedback response at feedback occasion 522 in slot j (e.g., due to the LBT procedure failure at feedback occasion 522 in slot j), no sidelink feedback response is received by transmitting UE 115a at feedback occasion 522 in slot j. In aspects, transmitting UE 115a may continue to monitor for a sidelink feedback transmission at feedback occasion 482 in slot j+1, which is the next sidelink feedback occasion, sequentially, in sidelink feedback window 510. In this case, as receiving UE 115b was able to transmit sidelink feedback response at feedback occasion 482 in slot j+1 (e.g., due to the LBT procedure success at feedback occasion 482 in slot j+1), transmitting UE 115a may receive sidelink feedback response at feedback occasion 482 in slot j+1.

During operation of wireless communication system 400, transmitting UE 115a detects a triggering condition associated with a feedback occasion of the plurality of feedback occasions.

In aspects, the triggering condition associated with a feedback occasion of the plurality of feedback occasions includes receiving a sidelink feedback response from the one or more receiving UEs in an associated feedback occasion to which sidelink transmission 480 was transmitted. For example, as described above, transmitting UE 115a may receive sidelink feedback response at feedback occasion 482 in slot j+1. In this example, receiving sidelink feedback response at feedback occasion 482 in slot j+1 is a triggering condition associated with slot j+1 of the plurality of sidelink feedback occasions covered by sidelink feedback window 510. In response to detecting the triggering condition associated with the feedback occasion of the plurality of feedback occasions, transmitting UE 115a may stop monitoring for a sidelink feedback response for sidelink transmission 480 over sidelink feedback window 510. For example, in response to receiving sidelink feedback response at feedback occasion 482 in slot j+1, transmitting UE 115a may stop monitoring for a sidelink feedback response for sidelink transmission 480 at the remaining feedback occasion(s) within sidelink feedback window 510. In this case, transmitting UE 115a may not monitor for a sidelink feedback response for sidelink transmission at feedback occasion 520 in slot j+2. As such, upon detecting the triggering condition, which in this example includes receiving sidelink feedback response at feedback occasion 482 in slot j+1, transmitting UE 115a may stop monitoring for a sidelink feedback response for sidelink transmission 480 at the remaining feedback occasion(s) within sidelink feedback window 510.

In aspects, if retransmission is determined based in part at least on specification, pre-configuration, configuration, indication from upper layer or indication in SCI 485 associated with transmission 480 when reaching the end of sidelink feedback window 510 (e.g., the LBT feedback timer 538 expires) or reaching the last (or final) sidelink feedback occasion covered by sidelink feedback window 510, the triggering condition associated with a feedback occasion of the plurality of feedback occasions may include reaching the end of sidelink feedback window 510 (e.g., the LBT feedback timer 538 expires), or reaching the last (or final) sidelink feedback occasion covered by sidelink feedback window 510, without receiving a sidelink feedback response for sidelink transmission 480. For example, transmitting UE 115a may monitor for a sidelink feedback response for sidelink transmission 480 over feedback occasions 522, 482 and 520 respectively in slots j, j+1, and j+2, and may not receive a sidelink feedback response (e.g., ACK or NACK sidelink feedback response for unicast or managed groupcast) for sidelink transmission 480 over any of feedback occasions 522, 482 and 520 respectively in slots j, j+1, and j+2. In this case, reaching the end of sidelink feedback window 510 (e.g., the LBT feedback timer 538 expires), or reaching the last (or final) sidelink feedback occasion in slot j+2 without receiving a sidelink feedback response for sidelink transmission 480 at any of feedback occasions 522, 482 and 520 respectively in slots j, j+1, and j+2 may be the triggering condition associated with slot j+2 (e.g., the last sidelink feedback occasion covered by sidelink feedback window 510). In response to detecting the triggering condition associated with the feedback occasion of the plurality of feedback occasions, transmitting UE 115a may stop monitoring for a sidelink feedback response (e.g., ACK or NACK sidelink feedback response for unicast or managed groupcast) for sidelink transmission 480 over sidelink feedback window 510. For example, in response to reaching the end of sidelink feedback window 510 (e.g., the LBT feedback timer 538 expires), or reaching the last (or final) sidelink feedback occasion in slot j+2 without receiving a sidelink feedback response for sidelink transmission 480 at any of feedback occasions 522, 482 and 520 respectively in slots j, j+1, and j+2, transmitting UE 115a may stop monitoring for a sidelink feedback response for sidelink transmission 480. In this case, transmitting UE 115a may not continue monitoring for a sidelink feedback response beyond slot j+2. As such, upon detecting the triggering condition, which in this example includes reaching the end of sidelink feedback window 510 (e.g., the LBT feedback timer 538 expires), or reaching the last (or final) sidelink feedback occasion in slot j+2 without receiving a sidelink feedback response (e.g., ACK or NACK sidelink feedback response for unicast or managed groupcast) for sidelink transmission 480 at any of feedback occasions 522, 482 and 520 respectively in slots j, j+1, and j+2, transmitting UE 115a may stop monitoring for a sidelink feedback response for sidelink transmission 480.

In alternative or additional aspects, in response to detecting the triggering condition associated with the feedback occasion of the plurality of feedback occasions, transmitting UE 115a may start a sidelink feedback timer. For example, in response to receiving a NACK in sidelink feedback response at feedback occasion 482 in slot j+1, or in response to reaching the end of sidelink feedback window 510 (e.g., the LBT feedback timer 538 expires) or the last (or final) sidelink feedback occasion in slot j+2 without receiving a sidelink feedback response (e.g., ACK or NACK sidelink feedback response for unicast or managed groupcast) for sidelink transmission 480 at any of feedback occasions respectively in slots j, j+1, and j+2, transmitting UE 115a may start HARQ round trip time (RTT) timer 532 at time 550 (e.g., after receiving a NACK at feedback occasion 482 in slot j+1) or HARQ RTT timer 536 at time 552 (e.g., when LBT feedback timer 538 expires or after reaching the last (or final) sidelink feedback occasion in slot j+2) respectively. In aspects, HARQ RTT timer 532 or HARQ RTT timer 536 may be a timer of a duration configured or activated for a UE to wait before a retransmission may be performed or derived based on the reservation of the first retransmission 484 as indicated in the SCI 485 transmitted with sidelink transmission 480 for a UE to wait before the retransmission 484 may be performed. In this case, at the expiration of HARQ RTT timer 532 or HARQ RTT timer 536, transmitting UE 115a may perform a retransmission of sidelink transmission 480 as sidelink retransmission 484. In aspects, transmitting sidelink retransmission 484 may include automatically starting HARQ retransmission timer 534 upon the expiration of HARQ RTT timer 532 or HARQ RTT timer 536, and transmitting sidelink retransmission 484 while HARQ retransmission timer 534 is running. In some aspects, transmitting UE 115a may additionally stop inactivity timer 530 at time 550 in response to starting HARQ RTT timer 532 or at time 552 in response to starting HARQ RTT timer 536. In some aspects, when the LBT feedback timer 538 is still running, transmitting UE 115a may additionally stop LBT feedback timer 538 at time 550 in response to starting HARQ RTT timer 532 or at time 552 in response to starting HARQ RTT timer 536.

During operation of wireless communication system 400, receiving UE 115b detects a triggering condition associated with a feedback occasion of the plurality of feedback occasions.

In aspects, the triggering condition associated with a feedback occasion of the plurality of feedback occasions includes performing a successful LBT procedure at a sidelink feedback occasion of the sidelink feedback occasions covered by sidelink feedback window 510. For example, receiving UE 115b may attempt to transmit sidelink feedback response to transmitting UE 115a at feedback occasion 522 in slot j of sidelink feedback window 510 by performing an LBT procedure for feedback occasion 482 in slot j. In this example, the LBT procedure for feedback occasion 522 in slot j may fail. As a result, receiving UE 115b may not be able to transmit sidelink feedback response to transmitting UE 115a at feedback occasion 522 in slot j, and no triggering condition is detected at slot j. At slot j+1, receiving UE 115b may continue attempting to transmit sidelink feedback response to transmitting UE 115a by performing an LBT procedure for feedback occasion 482 in slot j+1. In this example, the LBT procedure for feedback occasion 482 in slot j+1 may succeed. As a result, receiving UE 115b may transmit sidelink feedback response at feedback occasion 482 in slot j+1, and may detect the successful LBT procedure and transmission of sidelink feedback response as a triggering condition at feedback occasion 482 in slot j+1. In response to detecting the triggering condition at slot j+1, receiving UE 115b may stop performing an LBT procedure at each of remaining sidelink feedback occasion(s) within the rest of sidelink feedback window 510. For example, in response to performing a successful LBT procedure and transmitting sidelink feedback response at feedback occasion 482 in slot j+1, receiving UE 115b may stop performing an LBT procedure at each of remaining sidelink feedback occasion(s) within the rest of sidelink feedback window 510. In this case, receiving UE 115b may not perform an LBT procedure at feedback occasion 520 in slot j+2. As such, upon detecting the triggering condition, which in this example includes performing a successful LBT procedure and transmission of sidelink feedback response at feedback occasion 482 in slot j+1, receiving UE 115b may stop performing an LBT procedure at each of remaining sidelink feedback occasion(s) within the rest of sidelink feedback window 510.

In aspects, if retransmission is determined based in part at least on specification, pre-configuration, configuration, indication from upper layer or indication in SCI 485 associated with transmission 480 when reaching the end of sidelink feedback window 510 (e.g., the LBT feedback timer 538 expires) or reaching the last (or final) sidelink feedback occasion covered by sidelink feedback window 510, the triggering condition associated with a feedback occasion of the plurality of feedback occasions may include reaching the end of sidelink feedback window 510 (e.g., the LBT feedback timer 538 expires), or reaching the last (or final) sidelink feedback occasion covered by sidelink feedback window 510, without a successful LBT procedure. For example, receiving UE 115b may attempt to transmit sidelink feedback response (e.g., ACK or NACK sidelink feedback response for unicast or managed groupcast) to transmitting UE 115a over sidelink feedback window 510 by performing an LBT procedure, sequentially, at each of feedback occasions 522, 482 and 520 respectively in slots j, j+1, and j+2. In this example, the LBT procedure at each of feedback occasions 522, 482 and 520 respectively in lots j, j+1, and j+2 may fail, such that receiving UE 115b may not be able to win access to the transmission medium to transmit sidelink feedback response (e.g., ACK or NACK sidelink feedback response for unicast or managed groupcast) to transmitting UE 115a within sidelink feedback window 510. In this case, reaching the end of sidelink feedback window 510 (e.g., the LBT feedback timer 538 expires), or reaching the last (or final) sidelink feedback occasion in slot j+2 without a successful LBT procedure at any of feedback occasions 522, 482 and 520 respectively in slots j, j+1, and j+2 may be the triggering condition associated with slot j+2 (e.g., the last sidelink feedback occasion covered by sidelink feedback window 510). In response to detecting the triggering condition, receiving UE 115b may stop performing an LBT procedure at and/or after the end of sidelink feedback window 510. For example, in response to reaching the end of sidelink feedback window 510 (e.g., the LBT feedback timer 538 expires), or reaching the last (or final) sidelink feedback occasion in slot j+2 without a successful LBT procedure at any of feedback occasions 522, 482 and 520 respectively in slots j, j+1, and j+2, receiving UE 115b may stop performing an LBT procedure at and/or after the end of sidelink feedback window 510. In this case, receiving UE 115b may not continue performing an LBT procedure beyond slot j+2. As such, upon detecting the triggering condition, which in this example includes reaching the end of sidelink feedback window 510 (e.g., the LBT feedback timer 538 expires), or reaching the last (or final) sidelink feedback occasion in slot j+2 without a successful LBT procedure at any of feedback occasions 522, 482 and 520 respectively in slots j, j+1, and j+2, receiving UE 115b may stop performing an LBT procedure at and/or after the end of sidelink feedback window 510.

In alternative or additional aspects, in response to detecting the triggering condition associated with the feedback occasion of the plurality of feedback occasions, receiving UE 115b may start a sidelink feedback timer. For example, in response to transmitting a NACK in sidelink feedback response at feedback occasion 482 in slot j+1, or in response to reaching the end of sidelink feedback window 510 (e.g., the LBT feedback timer 538 expires) or the last (or final) sidelink feedback occasion in slot j+2 without a successful LBT procedure and transmission of sidelink feedback response (e.g., ACK or NACK sidelink feedback response for unicast or managed groupcast) at any of feedback occasions 522, 482 and 520 respectively in slots j, j+1, and j+2, receiving UE 115b may start HARQ RTT timer 532 at time 550 (e.g., after transmitting a NACK at feedback occasion 482 in slot j+1) or HARQ RTT timer 536 at time 552 (e.g., when LBT feedback timer 538 expires or after reaching the last (or final) sidelink feedback occasion in slot j+2) respectively. In aspects, HARQ RTT timer 532 or HARQ RTT timer 536 may be a timer of a duration configured or activated for a UE to wait before a retransmission may be received or derived based on the reservation of the first retransmission 484 as indicated in the SCI 485 received with sidelink transmission 480 for a UE to wait before the retransmission 484 may be received. In this case, at the expiration of HARQ RTT timer 532 or HARQ RTT timer 536, receiving UE 115b may receive retransmission of sidelink transmission 480 as sidelink retransmission 484 from transmitting UE 115a. In aspects, receiving sidelink retransmission 484 may include automatically starting HARQ retransmission timer 534 upon the expiration of HARQ RTT timer 532 or HARQ RTT timer 536, and receiving sidelink retransmission 484 while HARQ retransmission timer 534 is running. In aspects where sidelink feedback window 510 is defined as a number of sidelink feedback occasions, receiving UE 115b may additionally stop inactivity timer 530 at time 550 in response to starting HARQ RTT timer 532 or at time 552 in response to starting HARQ RTT timer 536. In some aspects when the LBT feedback timer 538 is still running, receiving UE 115b may additionally stop LBT feedback timer 538 at time 550 in response to starting HARQ RTT timer 532 or at time 552 in response to starting HARQ RTT timer 536.

In some aspects, the multiple sidelink feedback occasions may be allocated in mini-slots where a mini-slot may be a subset of a slot (e.g., a mini-slot with 2, 4 or 7 symbols within a slot with 14 symbols). For example, the sidelink feedback occasions 522, 482 and 520 may be allocated respectively in mini-slots j1, j2 or j3 within slot j. In some aspects, the multiple sidelink feedback occasions may be allocated in multiple symbols respectively within a slot (e.g., symbols 10, 11 or 12 at the end of a slot with symbols 0-13). For example, the sidelink feedback occasions 522, 482 and 520 may be allocated respectively at symbols 10, 11 or 12 within slot j.

FIG. 6 is a call flow diagram illustrating an example process that supports mechanisms for sidelink feedback reporting over an unlicensed spectrum in a wireless communication system according to one or more aspects. Operations of the process illustrated in FIG. 6 may be performed by a transmitting UE, such as transmitting UE 115a described above with reference to FIGS. 1-5, and one or more receiving UEs, such as receiving UE 115b described above with reference to FIGS. 1-5. In the discussion that follows, operations of the one or more receiving UEs are described with reference to receiving UE 115b. However, it should be noted that the operations described with reference to receiving UE 115b are equally applicable to any of the one or more receiving UEs, and the description with respect to receiving UE 115b is for illustrative purposes and not by way of limitations.

At step 1A, transmitting UE 115a may be pre-configured or configured with a configuration for a sidelink feedback window. For example, transmitting UE 115a may be pre-configured or configured with a SLU configuration received via an SLU_config element which may include one or more configurations for a sidelink feedback window. In aspects, the configuration of the sidelink feedback window may be based on QoS requirements, sidelink CAPC values and/or sidelink conditions. QoS requirements may include performance requirement related to different services or communications provided over the sidelink, and sidelink conditions may include current sidelink conditions determined based on measurements including CBR measurements, sidelink RSRP or RSSI measurements, LBT success rates, UE consistent LBT failure values etc. Based on the configuration of the SLU_config element, transmitting UE 115a may configure the sidelink feedback window. For example, in aspects where the sidelink feedback window is defined as a number of sidelink feedback occasions, the SLU_config element may specify one or more numbers of sidelink feedback occasions (e.g., indicated in a N_HARQ_occasions_list parameter) for different QoS profiles or PQI values of services or communications over sidelink, for different sidelink CAPC values related to different services or communications over the sidelink, for different CBR or sidelink RSRP or RSSI levels, and/or for different LBT successful rates or UE consistent LBT failure values. In these cases, transmitting UE 115a may store one or more numbers of sidelink feedback occasions for different QoS profiles or PQI values of services or communications over sidelink, for different sidelink CAPC values related to different services or communications over the sidelink, for different CBR or sidelink RSRP or RSSI levels, and/or got different LBT successful rates or UE consistent LBT failure values. In aspects where the sidelink feedback window is defined as a duration of an LBT feedback timer, the SLU_config element may specify one or more durations for the LBT feedback timer (e.g., indicated in a HARQ_feedback_timer_list parameter) for different QoS profiles or PQI values of services or communications over sidelink, for different sidelink CAPC values related to different services or communications over the sidelink, for different CBR or sidelink RSRP or RSSI levels, and/or for different LBT successful rates or UE consistent LBT failure values. In these cases, transmitting UE 115a may store one or more durations with which the LBT feedback timer may be configured for different QoS profiles or PQI values of services or communications over sidelink, for different sidelink CAPC values related to different services or communications over the sidelink, for different CBR or sidelink RSRP or RSSI levels, and/or for different LBT successful rates or UE consistent LBT failure values.

At step 1B, receiving UE 115b may be pre-configured or configured with a configuration for a sidelink feedback window. In this case, the pre-configuration or configuration of receiving UE 115b may be similar to the pre-configuration or configuration of transmitting UE 115a. For example, receiving UE 115b may be pre-configured or configured with a SLU configuration received via an SLU_config element. In aspects, the configuration of the sidelink feedback window may be based on QoS requirements, sidelink CAPC values and/or sidelink conditions, as mentioned above with respect to transmitting UE 115a. Based on the configuration of the SLU_config element, receiving UE 115b may configure the sidelink feedback window. For example, in aspects where the sidelink feedback window is defined as a number of sidelink feedback occasions, the SLU_config element may specify one or more numbers of sidelink feedback occasions (e.g., indicated in a N_HARQ_occasionslist parameter) for different QoS profiles or PQI values of services or communications over sidelink, for different sidelink CAPC values related to different services or communications over the sidelink, for different CBR or sidelink RSRP or RSSI levels, and/or for different LBT successful rates or UE consistent LBT failure values. In these cases, receiving UE 115b may store one or more numbers of sidelink feedback occasions for different QoS profiles or PQI values of services or communications over sidelink, for different sidelink CAPC values related to different services or communications over the sidelink, for different CBR or sidelink RSRP or RSSI levels, and/or for different LBT successful rates or UE consistent LBT failure values. In aspects where the sidelink feedback window is defined as a duration of an LBT feedback timer, the SLU_config element may specify one or more durations for the LBT feedback timer (e.g., indicated in a HARQ_feedback_timer_list parameter) for different QoS profiles or PQI values of services or communications over sidelink, for different sidelink CAPC values related to different services or communications over the sidelink, for different CBR or sidelink RSRP or RSSI levels, and/or for different LBT successful rates or UE consistent LBT failure values. In these cases, receiving UE 115b may store one or more durations with which the LBT feedback timer may be configured for different QoS profiles or PQI values of services or communications over sidelink, for different sidelink CAPC values related to different services or communications over the sidelink, for different CBR or sidelink RSRP or RSSI levels, and/or for different LBT successful rates or UE consistent LBT failure values.

At optional step 2, transmitting UE 115a may determine to adjust the sidelink feedback window (e.g., based on a number of sidelink feedback occasions or a duration of an LBT feedback timer as configured at step 1A). It is noted that step 2 may be optional, as, in some aspects, the process illustrated in FIG. 6 may go from steps 1A and 1B to step 7, discussed below. In aspects, transmitting UE 115a may determine to adjust the sidelink feedback window based on QoS requirements, sidelink CAPC values and/or sidelink conditions, as discussed above. For example, in aspects where the sidelink feedback window is defined as a number of sidelink feedback occasions, transmitting UE 115a may determine to adjust the sidelink feedback window by determining to adjust one or more numbers of sidelink feedback occasions in sidelink feedback window based on QoS requirements, sidelink CAPC values and/or sidelink conditions, as discussed above. In aspects where the sidelink feedback window is defined as a duration of an LBT feedback timer, transmitting UE 115a may determine to adjust the sidelink feedback window by determining to adjust the one or more durations for the LBT feedback timer based on QoS requirements, sidelink CAPC values and/or sidelink conditions, as discussed above. In aspects, transmitting UE 115a may activate the adjusted sidelink feedback window with adjusted one or more numbers of sidelink feedback occasions or with adjusted one or more durations for the LBT feedback timer, as discussed above, in receiving UE 115b by transmitting an activation message to receiving UE 115b. The activation message may be a PC5 RRC message, or a PC5 MAC-CE or SCI signaling containing adjusted one or more numbers of sidelink feedback occasions or adjusted one or more durations for the LBT feedback timer. At step 4, receiving UE 115b may respond to the activation message, indicating to transmitting UE 115a that the configuration of the sidelink feedback window at receiving UE 115b is as indicated in the activation message from transmitting UE 115a.

At optional steps 5 and 6, transmitting UE 115a may dynamically determine or adjust a duration for the sidelink feedback window with a number of sidelink feedback occasions or with a duration for the LBT feedback timer, as discussed above. It is noted that steps 5-6 may be optional, as, in some aspects, the process illustrated in FIG. 6 may go from steps 1A and 1B, or from step 4, to step 7, discussed below. In aspects, at step 5, transmitting UE 115a may determine that a TB is available for transmission. For example, a TB may be available to transmitted in or as a sidelink transmission to the one or more receiving UEs (including receiving UE 115b).

At step 6, transmitting UE 115a may determine the sidelink feedback window based on QoS profile or PQI value associated with the TB and/or a sidelink condition determined based, at least in part, on sidelink measurements. In aspects, the QoS profile or PQI value associated with the TB may include one or more of QoS parameters such as a priority level of the TB transmission, a reliability requirement for the TB transmission, a data volume of the TB, a maximum data rate for the TB, a PDB or remaining PDB, etc. In aspects, the sidelink measurements for determining the sidelink condition may include CBR measurements, sidelink RSRP measurements, an LBT success rate, etc. In aspects where the sidelink feedback window is defined as a number of sidelink feedback occasions, transmitting UE 115a may determine the sidelink feedback window by determining a number of sidelink feedback occasions to include in the sidelink feedback window based on one or more QoS parameters of QoS profile or PQI value and/or sidelink conditions, as discussed above. In aspects where the sidelink feedback window is defined as a duration of an LBT feedback timer, transmitting UE 115a may determine the sidelink feedback window by determining a duration for the LBT feedback timer based on one or more QoS parameters of QoS profile or PQI value and/or sidelink conditions, as discussed above.

At step 7, transmitting UE 115a may select a resource pool including a plurality of sidelink feedback occasions meeting the pre-configured or configured (e.g., at step 1A), activated (e.g., at step 3), or determined (e.g., at step 6) sidelink feedback window. For example, in aspects where the sidelink feedback window is defined as a number of sidelink feedback occasions, transmitting UE 115a may select a resource pool that includes at least a number of sidelink feedback occasions pre-configured or configured or activated or determined based on the QoS requirements or sidelink CAPC value associated with the TB and/or the sidelink condition. In aspects where the sidelink feedback window is defined as a duration of an LBT feedback timer, transmitting UE 115a may select a resource pool that includes a plurality of sidelink feedback occasions within a duration for the LBT feedback timer pre-configured or configured or activated or determined based on the QoS requirements or sidelink CAPC value associated with the TB and/or the sidelink condition. In aspects, transmitting UE 115a may signal the sidelink feedback window determined based on QoS requirements or sidelink CAPC value associated with the TB and/or a sidelink condition to the one or more receiving UEs (including receiving UE 115b) in the SCI (e.g., SCI part 2) to be included in the sidelink transmission to be transmitted by transmitting UE 115a to the one or more receiving UEs (including receiving UE 115b) where the sidelink feedback window may be indicated with a determined number of sidelink feedback occasions, or may be indicated with a determined duration for the LBT feedback timer.

At step 8, transmitting UE 115a may perform an LBT procedure to obtain access to the transmitting medium in order to transmit the initial sidelink transmission to the one or more receiving UEs (including receiving UE 115b). In aspects, upon a successful LBT procedure, transmitting UE 115a may transmit the initial sidelink transmission to the one or more receiving UEs (including receiving UE 115b). As noted above, transmitting UE 115a may include, in an SCI message included in the sidelink transmission, a determined sidelink feedback window (e.g., a number of sidelink feedback occasions, or a duration for the LBT feedback timer).

At step 9A, transmitting UE 115a starts monitoring, in response to transmitting the sidelink transmission to the one or more receiving UEs, for a sidelink feedback response for the sidelink transmission over the sidelink feedback window. For example, as noted above, in aspects where the sidelink feedback window is defined as a number of sidelink feedback occasions, transmitting UE 115a may start or restart an inactivity timer at the slot after the sidelink transmission was transmitted to the one or more receiving UEs, such that the duration of the inactivity timer covers the number of sidelink feedback occasions covered by the sidelink feedback window. In these cases, transmitting UE 115a may monitor for a sidelink feedback response for the sidelink transmission over each sidelink feedback occasion covered by the sidelink feedback window while the inactivity timer is running. In aspects where the sidelink feedback window is defined as a duration of an LBT feedback timer, transmitting UE 115a may start the LBT feedback timer in response to transmitting the sidelink transmission to the one or more receiving UEs and may monitor for a sidelink feedback response for the sidelink transmission over each sidelink feedback occasion covered by the sidelink feedback window while the LBT feedback timer is running.

At step 9B, on receiving UE 115b's side, receiving UE 115b, in response to receiving the sidelink transmission from transmitting UE 115a, may start or restart its inactivity timer (e.g., in aspects where the sidelink feedback window is defined as a number of sidelink feedback occasions) or LBT feedback timer (e.g., in aspects where the sidelink feedback window is defined as a duration of an LBT feedback timer) at the slot after receiving the sidelink transmission from transmitting UE 115a, such that the duration of the inactivity timer or LBT feedback timer covers the number of sidelink feedback occasions, and may prepare a sidelink feedback response for the sidelink transmission (e.g., an ACK or a NACK depending on whether sidelink transmission 480 was successfully received or decoded by receiving UE 115b or not) and may start attempting to transmit the sidelink feedback response to transmitting UE 115a over the sidelink feedback window (e.g., while the inactivity timer or LBT feedback timer is running). For example, at step 10, receiving UE may begin performing an LBT procedure at each sidelink feedback occasion covered by the sidelink feedback window in order to obtain access to the transmission medium and transmit the feedback response to transmitting UE 115a. In aspects, receiving UE 115b may attempt to transmit the sidelink feedback response to transmitting UE 115a over each sidelink feedback occasion within the sidelink feedback window, sequentially. In aspects, receiving UE 115a may perform an LBT procedure at each sidelink feedback occasion covered by the sidelink feedback window and, if the LBT procedure at a sidelink feedback occasion fails, receiving UE 115a may not transmit the sidelink feedback response to transmitting UE 115a at the failed sidelink feedback occasion, and may continue to the next sidelink feedback occasion covered by the sidelink feedback window. Receiving UE 115b may continue to perform an LBT procedure at each sidelink feedback occasion covered by the sidelink feedback window until the LBT procedure is successful or until the end of the sidelink feedback window (e.g., after the last sidelink feedback occasion or the expiration of LBT feedback timer). When the LBT procedure at a sidelink feedback occasion is successful, receiving UE 115a may transmit the sidelink feedback response to transmitting UE 115a in the sidelink feedback occasion in which the LBT procedure was successful. Transmitting UE 115a may receive the sidelink feedback response in the sidelink feedback occasion in which the LBT procedure by receiving UE 115b was successful.

In aspects, where the sidelink feedback response includes an ACK, receiving UE 115b may not expect a retransmission from transmitting UE 115a. However, where the sidelink feedback response includes a NACK, receiving UE 115b may expect a retransmission from transmitting UE 115a. Therefore, upon receiving a NACK from receiving UE 115b, transmitting UE 115a may retransmit the sidelink transmission to the one or more UEs or to receiving UE 115b, depending on the sidelink feedback implementation. In other cases, receiving UE 115b may intend to transmit a feedback response to transmitting UE 115a but may not be able to perform a successful LBT procedure at any of the sidelink feedback occasions covered by the sidelink feedback window. In this case, transmitting UE 115a may not receive a sidelink feedback response (e.g., ACK or NACK for unicast or managed groupcast) within the sidelink feedback window. In this case, however, receiving UE 115b may expect a retransmission from transmitting UE 115a, based in part at least on specification, pre-configuration, configuration, indication from upper layer or indication in SCI associated with the initial transmission at step 8 (e.g., enable retransmission for a sidelink service or communication when reaching the end of the sidelink feedback window) or depending on the sidelink feedback implementation (e.g., for ACK/NACK based HARQ feedback for unicast or managed groupcast, retransmission may be enabled without receiving an ACK or NACK (discontinuous transmission of HARQ feedback). As such, upon reaching the end of the sidelink feedback window (e.g., after the last sidelink feedback occasion or the expiration of LBT feedback timer) without receiving a sidelink feedback response (e.g., ACK or NACK for unicast or managed groupcast), transmitting UE 115a may retransmit the sidelink transmission to the one or more UEs or to receiving UE 115b, based in part at least on specification, pre-configuration, configuration, indication from upper layer or indication in SCI associated with the initial transmission at step 8 or depending on the sidelink feedback implementation.

At step 11B, receiving UE 115b may, in response to successfully transmitting a NACK message to transmitting UE 115a over a sidelink feedback occasion of the sidelink feedback occasions covered by the sidelink feedback window, or in response to reaching the end of the sidelink feedback window without a successful LBT procedure at any of the sidelink feedback occasions covered by the sidelink feedback window, start a sidelink feedback timer after transmitting the NACK or after reaching the end of the sidelink feedback window (e.g., after the last sidelink feedback occasion or the expiration of LBT feedback timer) without a successful LBT procedure (e.g., if retransmission is determined as described above in details). In aspects, the sidelink feedback timer may be a HARQ RTT timer. In this case, at the expiration of the HARQ RTT timer, receiving UE 115b may expect to receive a retransmission of the sidelink transmission from transmitting UE 115a (e.g., if retransmission is determined as described above in details) with HARQ retransmission timer started upon the expiration of HARQ RTT timer. In aspects where the sidelink feedback window is defined as a number of sidelink feedback occasions, receiving UE 115b may stop the inactivity timer in response to starting the HARQ RTT timer. In aspects where the sidelink feedback window is defined as a duration of an LBT feedback timer, receiving UE 115b may stop the LBT feedback timer in response to starting the HARQ RTT timer.

At step 11A, transmitting UE 115a may, in response to receiving a NACK message from receiving UE 115b over a sidelink feedback occasion of the sidelink feedback occasions covered by the sidelink feedback window, or in response to reaching the end of the sidelink feedback window without receiving a sidelink feedback response (e.g., ACK or NACK for unicast or managed groupcast) for the sidelink transmission at any of the sidelink feedback occasions covered by the sidelink feedback window, start a sidelink feedback timer after receiving the NACK or after reaching the end of the sidelink feedback window (e.g., after the last sidelink feedback occasion or the expiration of LBT feedback timer) without receiving a sidelink feedback response (e.g., ACK or NACK for unicast or managed groupcast) if retransmission is determined as described above in details. In aspects, the sidelink feedback timer may be a HARQ RTT timer. In this case, at the expiration of the HARQ RTT timer, transmitting UE 115a may perform a retransmission of the sidelink transmission (e.g., if retransmission is determined as described above in details) with HARQ retransmission timer started upon the expiration of HARQ RTT timer. For example, at step 12, transmitting UE 115a may perform an LBT procedure to obtain access for transmitting the sidelink retransmission to receiving UE 115b while the HARQ retransmission timer is running. Upon a successful LBT procedure, transmitting UE 115a may transmit the sidelink retransmission to receiving UE 115b. In aspects where the sidelink feedback window is defined as a number of sidelink feedback occasions, transmitting UE 115a may stop the inactivity timer in response to starting the HARQ RTT timer. In aspects where the sidelink feedback window is defined as a duration of an LBT feedback timer, transmitting UE 115a may stop the LBT feedback timer in response to starting the HARQ RTT timer.

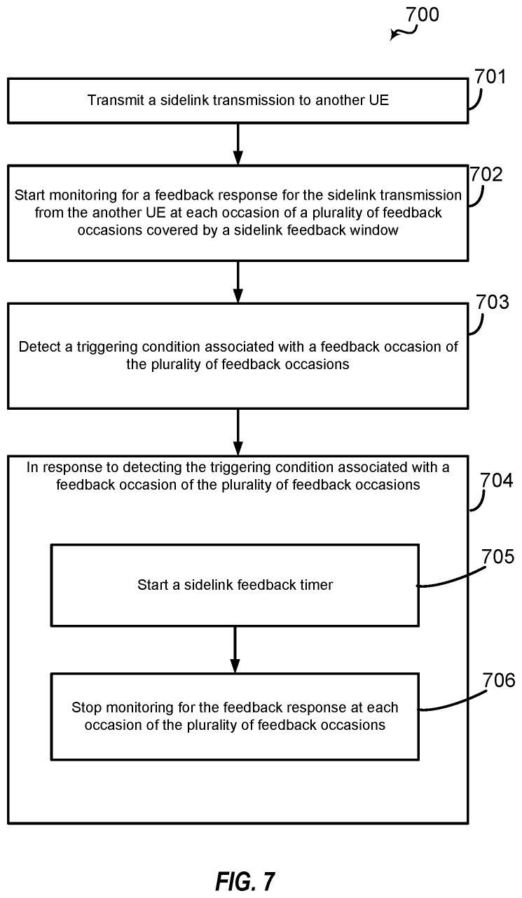

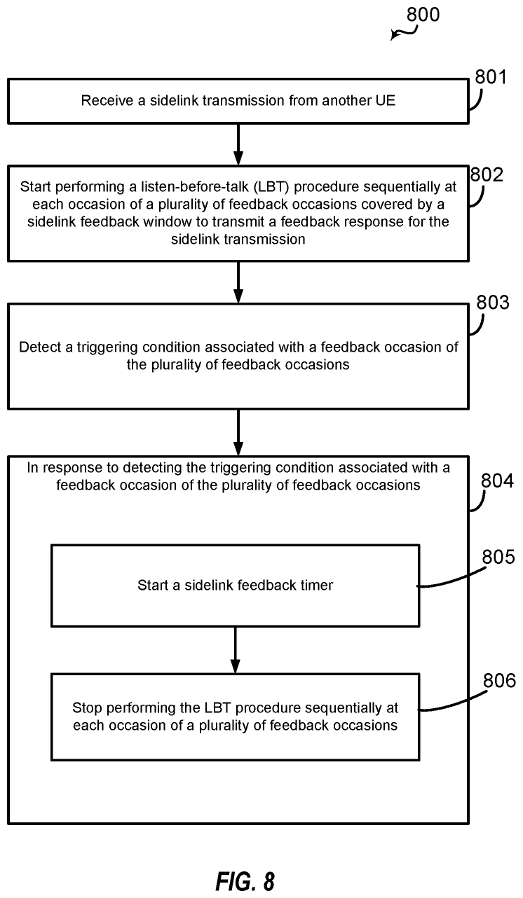

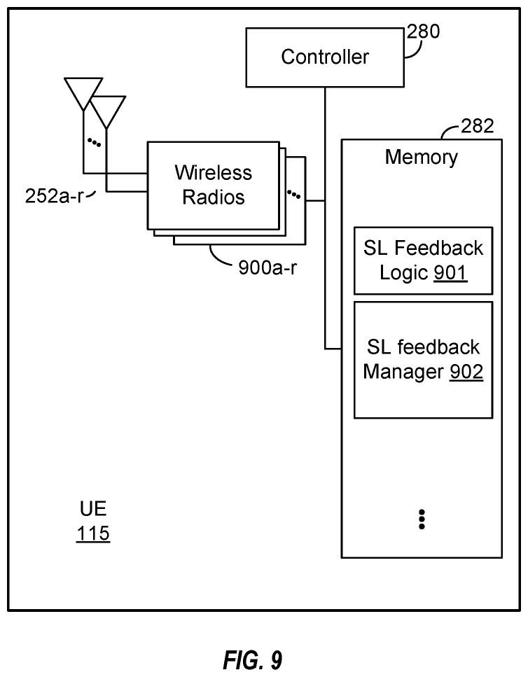

FIG. 7 is a flow diagram illustrating an example process 700 that supports mechanisms for sidelink feedback reporting over an unlicensed spectrum in a wireless communication system according to one or more aspects. Operations of process 700 may be performed by a UE, such as transmitting UE 115a described above with reference to FIGS. 1-6, or a UE described with reference to FIG. 9. For example, example operations (also referred to as “blocks”) of process 400 may enable UE 115 to support mechanisms for sidelink feedback reporting over an unlicensed spectrum. FIG. 9 is a block diagram of an example UE 115 that supports mechanisms for sidelink feedback reporting over an unlicensed spectrum in a wireless communication system according to one or more aspects. UE 115 may be configured to perform operations, including the blocks of a process described with reference to FIGS. 7 and 8. In some implementations, UE 115 includes the structure, hardware, and components shown and described with reference to UE 115 of FIGS. 1-3. For example, UE 115 includes controller 280, which operates to execute logic or computer instructions stored in memory 282, as well as controlling the components of UE 115 that provide the features and functionality of UE 115. UE 115, under control of controller 280, transmits and receives signals via wireless radios 901a-r and antennas 252a-r. Wireless radios 901a-r include various components and hardware, as illustrated in FIG. 2 for UE 115, including modulator and demodulators 254a-r, MIMO detector 256, receive processor 258, transmit processor 264, and TX MIMO processor 266.

In block 701, the UE (e.g., transmitting UE 115a) transmits a sidelink transmission to another UE (e.g., receiving UE 115b). In order to implement the functionality for such operations, UE 115, under control of controller/processor 280, may transmit a sidelink transmission to another UE via wireless radios 601a-r and antennas 252a-r. In aspects, UE 115 may perform operations to transmit a sidelink transmission to another UE according to operations and functionality as described above with reference to transmitting UE 115a and as illustrated in FIGS. 1-6.

In block 702, the UE starts monitoring for a feedback response for the sidelink transmission from the another UE at each occasion of a plurality of feedback occasions covered by a sidelink feedback window. In order to implement the functionality for such operations, UE 115, under control of controller/processor 280, executes sidelink feedback logic 901, stored in memory 282. The functionality implemented through the execution environment of sidelink feedback logic 901 allows for UE 115 to perform operations to start monitoring for a feedback response for the sidelink transmission from the another UE at each occasion of the plurality of feedback occasions covered by the sidelink feedback window according to the various aspects herein. In aspects, UE 115 may perform operations to start monitoring for a feedback response for the sidelink transmission from the another UE at each occasion of the plurality of feedback occasions covered by the sidelink feedback window according to operations and functionality as described above with reference to transmitting UE 115a and as illustrated in FIGS. 1-6.

In block 703, the UE detects a triggering condition associated with a feedback occasion of the plurality of feedback occasions. In order to implement the functionality for such operations, UE 115, under control of controller/processor 280, executes sidelink feedback logic 901, stored in memory 282. The functionality implemented through the execution environment of sidelink feedback logic 901 allows for UE 115 to perform operations to detect a triggering condition associated with a feedback occasion of the plurality of feedback occasions according to the various aspects herein. In aspects, UE 115 may perform operations to detect a triggering condition associated with a feedback occasion of the plurality of feedback occasions according to operations and functionality as described above with reference to transmitting UE 115a and as illustrated in FIGS. 1-6.

In block 704, the UE performs operations in response to detecting the triggering condition associated with a feedback occasion of the plurality of feedback occasions. For example, in block 705, the UE starts a sidelink feedback timer in response to detecting the triggering condition associated with a feedback occasion of the plurality of feedback occasions. In order to implement the functionality for such operations, UE 115, under control of controller/processor 280, executes sidelink feedback logic 901, stored in memory 282. The functionality implemented through the execution environment of sidelink feedback logic 901 allows for UE 115 to perform operations to start a sidelink feedback timer in response to detecting the triggering condition associated with a feedback occasion of the plurality of feedback occasions according to the various aspects herein. In aspects, UE 115 may perform operations to start a sidelink feedback timer in response to detecting the triggering condition associated with a feedback occasion of the plurality of feedback occasions according to operations and functionality as described above with reference to transmitting UE 115a and as illustrated in FIGS. 1-6.

In block 706, the UE stops monitoring for the feedback response at each occasion of the plurality of feedback occasions covered by the sidelink feedback window in response to detecting the triggering condition associated with a feedback occasion of the plurality of feedback occasions. In order to implement the functionality for such operations, UE 115, under control of controller/processor 280, executes sidelink feedback logic 901, stored in memory 282. The functionality implemented through the execution environment of sidelink feedback logic 901 allows for UE 115 to perform operations to stop monitoring for the feedback response at each occasion of the plurality of feedback occasions covered by the sidelink feedback window in response to detecting the triggering condition associated with a feedback occasion of the plurality of feedback occasions according to the various aspects herein. In aspects, UE 115 may perform operations to stop monitoring for the feedback response at each occasion of the plurality of feedback occasions covered by the sidelink feedback window in response to detecting the triggering condition associated with a feedback occasion of the plurality of feedback occasions according to operations and functionality as described above with reference to transmitting UE 115a and as illustrated in FIGS. 1-6.

FIG. 8 is a flow diagram illustrating an example process 800 that provides mechanisms for sidelink feedback reporting over an unlicensed spectrum in a wireless communication system according to one or more aspects. Operations of process 800 may be performed by a UE, such as receiving UE 115b described above with reference to FIGS. 1-6. For example, example operations (also referred to as “blocks”) of process 800 may enable UE 115 (e.g., UE 115 of FIG. 9) to support mechanisms for sidelink feedback reporting over an unlicensed spectrum.

In block 801, the UE (e.g., receiving UE 115b) receives a sidelink transmission from another UE (e.g., transmitting UE 115a). In order to implement the functionality for such operations, UE 115, under control of controller/processor 280, may receive a sidelink transmission from another UE via wireless radios 601a-r and antennas 252a-r. In aspects, UE 115 may perform operations to receive a sidelink transmission from another UE according to operations and functionality as described above with reference to receiving UE 115b and as illustrated in FIGS. 1-6.

In block 802, the UE starts performing an LBT procedure sequentially at each occasion of a plurality of feedback occasions covered by a sidelink feedback window to transmit a feedback response for the sidelink transmission. In order to implement the functionality for such operations, UE 115, under control of controller/processor 280, executes sidelink feedback manager 902, stored in memory 282. The functionality implemented through the execution environment of sidelink feedback manager 902 allows for UE 115 to perform operations to start performing an LBT procedure sequentially at each occasion of a plurality of feedback occasions covered by a sidelink feedback window to transmit a feedback response for the sidelink transmission according to the various aspects herein. In aspects, UE 115 may perform operations to start performing an LBT procedure sequentially at each occasion of a plurality of feedback occasions covered by a sidelink feedback window to transmit a feedback response for the sidelink transmission according to operations and functionality as described above with reference to receiving UE 115b and as illustrated in FIGS. 1-6.

In block 803, the UE detects a triggering condition associated with a feedback occasion of the plurality of feedback occasions. In order to implement the functionality for such operations, UE 115, under control of controller/processor 280, executes sidelink feedback manager 902, stored in memory 282. The functionality implemented through the execution environment of sidelink feedback manager 902 allows for UE 115 to perform operations to detect a triggering condition associated with a feedback occasion of the plurality of feedback occasions according to the various aspects herein. In aspects, UE 115 may perform operations to detect a triggering condition associated with a feedback occasion of the plurality of feedback occasions according to operations and functionality as described above with reference to receiving UE 115b and as illustrated in FIGS. 1-6.

In block 804, the UE performs operations in response to detecting the triggering condition associated with a feedback occasion of the plurality of feedback occasions. For example, in block 805, the UE starts a sidelink feedback timer in response to detecting the triggering condition associated with a feedback occasion of the plurality of feedback occasions. In order to implement the functionality for such operations, UE 115, under control of controller/processor 280, executes sidelink feedback manager 902, stored in memory 282. The functionality implemented through the execution environment of sidelink feedback manager 902 allows for UE 115 to perform operations to start a sidelink feedback timer in response to detecting the triggering condition associated with a feedback occasion of the plurality of feedback occasions according to the various aspects herein. In aspects, UE 115 may perform operations to start a sidelink feedback timer in response to detecting the triggering condition associated with a feedback occasion of the plurality of feedback occasions according to operations and functionality as described above with reference to receiving UE 115b and as illustrated in FIGS. 1-6.

In block 806, the UE stops performing the LBT procedure sequentially at each occasion of a plurality of feedback occasions in response to detecting the triggering condition associated with a feedback occasion of the plurality of feedback occasions. In order to implement the functionality for such operations, UE 115, under control of controller/processor 280, executes sidelink feedback manager 902, stored in memory 282. The functionality implemented through the execution environment of sidelink feedback manager 902 allows for UE 115 to perform operations to stop performing the LBT procedure sequentially at each occasion of a plurality of feedback occasions in response to detecting the triggering condition associated with a feedback occasion of the plurality of feedback occasions according to the various aspects herein. In aspects, UE 115 may perform operations to stop performing the LBT procedure sequentially at each occasion of a plurality of feedback occasions in response to detecting the triggering condition associated with a feedback occasion of the plurality of feedback occasions according to operations and functionality as described above with reference to receiving UE 115b and as illustrated in FIGS. 1-6.

In one or more aspects, techniques for supporting mechanisms for sidelink feedback reporting over an unlicensed spectrum in a wireless communication system according to one or more aspects may include additional aspects, such as any single aspect or any combination of aspects described below or in connection with one or more other processes or devices described elsewhere herein. In a first aspect, supporting mechanisms for sidelink feedback reporting over an unlicensed spectrum in a wireless communication system may include an apparatus configured to transmit a sidelink transmission to another UE, to start monitoring for a feedback response for the sidelink transmission from the another UE at each occasion of a plurality of feedback occasions covered by a sidelink feedback window, to detect a triggering condition associated with a feedback occasion of the plurality of feedback occasions, and, in response to detecting the triggering condition associated with a feedback occasion of the plurality of feedback occasions, to start a sidelink feedback timer and to stop monitoring for the feedback response at each occasion of the plurality of feedback occasions. Additionally, the apparatus may perform or operate according to one or more aspects as described below. In some implementations, the apparatus includes a wireless device, such as a UE (e.g., transmitting UE 115a as described above). In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, alone or in combination with the first aspect, starting monitoring for the feedback response for the sidelink transmission from the another UE at each occasion of the plurality of feedback occasions covered by the sidelink feedback window includes determining a configuration of the plurality of feedback occasions based on one or more of a configuration based on one or more of QoS for sidelink communication or sidelink conditions, the configuration defining the plurality of feedback occasions covered by the sidelink feedback window for monitoring for the feedback response, an activation of the plurality of feedback occasions covered by the sidelink feedback window for monitoring for the feedback response based on the one or more of QoS for sidelink communication or sidelink conditions, or a dynamic signaling indicating the plurality of feedback occasions covered by the sidelink feedback window, wherein the dynamic signaling is based on one or more of QoS for a TB associated with the sidelink transmission or sidelink conditions.

In a third aspect, alone or in combination with one or more of the first aspect or the second aspect, the activation of the plurality of feedback occasions covered by the sidelink feedback window includes indicating the plurality of feedback occasions for the another UE via a configuration message transmitted from the UE to the another UE, the configuration message including a MAC-CE.

In a fourth aspect, alone or in combination with one or more of the first aspect through the third aspect, the dynamic signaling indicating the plurality of feedback occasions covered by the sidelink feedback window includes determining the plurality of feedback occasions covered by the sidelink feedback window based on the one or more of QoS for the TB associated with the sidelink transmission or sidelink conditions, the sidelink conditions based, at least in part, on sidelink measurements.

In a fifth aspect, alone or in combination with the fourth aspect, the dynamic signaling indicating the plurality of feedback occasions covered by the sidelink feedback window includes selecting a resource pool including multiple feedback occasions meeting the one or more of QoS for the TB associated with the sidelink transmission or sidelink conditions.

In a sixth aspect, alone or in combination with one or more of the fourth aspect through the fifth aspect, the dynamic signaling indicating the plurality of feedback occasions covered by the sidelink feedback window includes selecting the plurality of feedback occasions covered by the sidelink feedback window from the selected resource pool.

In a seventh aspect, alone or in combination with one or more of the fourth aspect through the sixth aspect, the dynamic signaling indicating the plurality of feedback occasions covered by the sidelink feedback window includes transmitting, to the another UE, an indication including one or more of: a number of feedback occasions in the plurality of feedback occasions covered by the sidelink feedback window or a duration of time covering the plurality of feedback occasions.

In an eighth aspect, alone or in combination with one or more of the fourth aspect through the seventh aspect, the indication is transmitted in sidelink control information concurrently transmitted with the sidelink transmission to the another UE.

In a ninth aspect, alone or in combination with one or more of the first aspect through the eighth aspect, the QoS for the TB associated with the sidelink transmission includes at least one QoS profile or 5QI that includes one or more of a priority level of the sidelink transmission, a reliability requirement for the sidelink transmission, a data volume, a maximum data rate, and/or a packet delay budget (PDB) or remaining PDB.

In a tenth aspect, alone or in combination with one or more of the first aspect through the ninth aspect, the sidelink conditions are based, at least in part, on sidelink measurements including one or more of a CBR, a sidelink RSRP, or an LBT success rate.

In an eleventh aspect, alone or in combination with one or more of the first aspect through the tenth aspect, starting monitoring for the feedback response at each occasion of the plurality of feedback occasions covered by the sidelink feedback window includes determining the sidelink feedback window including a number of feedback occasions in the plurality of feedback occasions covered by the sidelink feedback window.

In a twelfth aspect, alone or in combination with the eleventh aspect, starting monitoring for the feedback response at each occasion of the plurality of feedback occasions covered by the sidelink feedback window includes extending an inactivity timer associated with transmitting the sidelink transmission to the another UE to a duration configured to cover the number of feedback occasions after transmitting the sidelink transmission to the another UE.

In a thirteenth aspect, alone or in combination with one or more of the eleventh aspect through the twelfth aspect, starting monitoring for the feedback response at each occasion of the plurality of feedback occasions covered by the sidelink feedback window includes starting monitoring for the feedback response for the sidelink transmission from the another UE over the number of feedback occasions in the plurality of feedback occasions while the inactivity timer is running.

In a fourteenth aspect, alone or in combination with one or more of the eleventh aspect through the thirteenth aspect, starting monitoring for the feedback response at each occasion of the plurality of feedback occasions covered by the sidelink feedback window includes starting the sidelink feedback timer after receiving the feedback response, wherein starting the sidelink feedback timer causes the UE to stop the inactivity timer.

In a fifteenth aspect, alone or in combination with one or more of the first aspect through the fourteenth aspect, extending the inactivity timer includes starting the inactivity timer in response to transmitting the sidelink transmission to the another UE.

In a sixteenth aspect, alone or in combination with one or more of the first aspect through the fifteenth aspect, starting monitoring for the feedback response at each occasion of the plurality of feedback occasions covered by the sidelink feedback window includes determining the plurality of feedback occasions based on a duration for an LBT feedback timer, the duration for the LBT feedback timer covering the plurality of feedback occasions.

In a seventeenth aspect, alone or in combination with the sixteenth aspect, starting monitoring for the feedback response at each occasion of the plurality of feedback occasions covered by the sidelink feedback window includes starting the LBT feedback timer.

In an eighteenth aspect, alone or in combination with one or more of the sixteenth aspect through the seventeenth aspect, starting monitoring for the feedback response at each occasion of the plurality of feedback occasions covered by the sidelink feedback window includes starting monitoring for the feedback response for the sidelink transmission from the another UE while the LBT feedback timer is running.

In a nineteenth aspect, alone or in combination with one or more of the sixteenth aspect through the eighteenth aspect, starting monitoring for the feedback response at each occasion of the plurality of feedback occasions covered by the sidelink feedback window includes starting the sidelink feedback timer after receiving the feedback response.

In a twentieth aspect, alone or in combination with one or more of the sixteenth aspect through the nineteenth aspect, starting the sidelink feedback timer causes the UE to stop the LBT feedback timer.

In a twenty-first aspect, alone or in combination with one or more of the first aspect through the twentieth aspect, starting the LBT feedback timer includes starting the LBT feedback timer in response to one of transmitting the sidelink transmission to the another UE, or before a first feedback occasion of the plurality of feedback occasions.

In a twenty-second aspect, alone or in combination with one or more of the first aspect through the twenty-first aspect, the triggering condition associated with the feedback occasion of the plurality of feedback occasions includes one or more of receiving the feedback response at the feedback occasion associated with the triggering condition, or reaching the end of the sidelink feedback window without receiving the feedback response from the another UE based, at least in part, on a type of the sidelink feedback.

In a twenty-third aspect, alone or in combination with one or more of the first aspect through the twenty-second aspect, the feedback occasion associated with the triggering condition at which the feedback response is received by the UE includes a feedback occasion of the plurality of feedback occasion with a successful LBT procedure by the another UE.

In a twenty-fourth aspect, alone or in combination with one or more of the first aspect through the twenty-third aspect, the techniques of the first aspect include retransmitting the sidelink transmission to the another UE in response to reaching the end of the sidelink feedback window without receiving the feedback response from the another UE.

In a twenty-fifth aspect, alone or in combination with one or more of the first aspect through the twenty-fourth aspect, retransmitting the sidelink transmission to the another UE includes starting a sidelink retransmission timer upon expiration of the feedback timer.

In a twenty-sixth aspect, alone or in combination with the twenty-fifth aspect, retransmitting the sidelink transmission to the another UE includes retransmitting the sidelink transmission to the another UE while the sidelink retransmission timer is running.

In a twenty-seventh aspect, alone or in combination with one or more of the first aspect through the twenty-sixth aspect, the techniques of the first aspect include retransmitting the sidelink transmission to the another UE when the feedback response received from the another UE includes a NACK for the sidelink transmission.

In a twenty-eighth aspect, alone or in combination with the twenty-seventh aspect, the techniques of the first aspect include foregoing retransmitting the sidelink transmission to the another UE when the feedback response received from the another UE includes an ACK for the sidelink transmission.

In a twenty-ninth aspect, techniques for supporting mechanisms for sidelink feedback reporting over an unlicensed spectrum in a wireless communication system may include an apparatus configured to receive a sidelink transmission from another UE, to start performing an LBT procedure sequentially at each occasion of a plurality of feedback occasions covered by a sidelink feedback window to transmit a feedback response for the sidelink transmission, to detect a triggering condition associated with a feedback occasion of the plurality of feedback occasions, and, in response to detecting the triggering condition associated with a feedback occasion of the plurality of feedback occasions, to start a sidelink feedback timer and to stop performing the LBT procedure sequentially at each occasion of a plurality of feedback occasions. Additionally, the apparatus may perform or operate according to one or more aspects as described below. In some implementations, the apparatus includes a wireless device, such as a UE (e.g., receiving UE 115b as described above). In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a thirtieth aspect, alone or in combination with one or more of the twenty-ninth aspect through the twenty-ninth aspect, starting performing the LBT procedure sequentially at each occasion of a plurality of feedback occasions includes determining a configuration of the plurality of feedback occasions based on one or more of a configuration based on one or more of QoS for sidelink communication or sidelink conditions, the configuration defining the plurality of feedback occasions for monitoring for the feedback response, an activation of the plurality of feedback occasions for transmitting the feedback response based on the one or more of QoS for sidelink communication or sidelink conditions, or a dynamic signaling indicating the configuration of the plurality of feedback occasions, wherein the dynamic signaling is based on one or more of QoS for a TB associated with the sidelink transmission or sidelink conditions.

In a thirty-first aspect, alone or in combination with one or more of the twenty-ninth aspect through the thirtieth aspect, the activation of the plurality of feedback occasions includes receiving an indication of the plurality of feedback occasions from the another UE via a configuration message, the configuration message including a MAC-CE.

In a thirty-second aspect, alone or in combination with one or more of the twenty-ninth aspect through the thirty-first aspect, the dynamic signaling indicating the plurality of feedback occasions includes receiving, from the another UE, an indication of the plurality of feedback occasions.

In a thirty-third aspect, alone or in combination with the thirty-second aspect, the indication is received in sidelink control information concurrently transmitted with the sidelink transmission.

In a thirty-fourth aspect, alone or in combination with one or more of the thirty-second aspect through the thirty-third aspect, the plurality of feedback occasions is determined by the another UE based on one or more of QoS for a TB associated with the sidelink transmission or sidelink conditions, the indication of the plurality of feedback occasions including one or more of a number of feedback occasions in the plurality of feedback occasions or a duration of time covering the plurality of feedback occasions.

In a thirty-fifth aspect, alone or in combination with one or more of the thirty-second aspect through the thirty-fourth aspect, the plurality of feedback occasions is selected from a resource pool determined by the another UE to include multiple feedback occasions meeting the one or more of the QoS of the TB or the sidelink conditions, based, at least in part, on sidelink measurements.

In a thirty-sixth aspect, alone or in combination with one or more of the twenty-ninth aspect through the thirty-fifth aspect, the QoS for the TB associated with the sidelink transmission includes at least one QoS profile or 5QI that includes one or more of a priority level of the sidelink transmission, a reliability requirement for the sidelink transmission, a data volume, a maximum data rate, and/or a PDB or remaining PDB.

In a thirty-seventh aspect, alone or in combination with one or more of the twenty-ninth aspect through the thirty-sixth aspect, the sidelink conditions are based, at least in part, on sidelink measurements including one or more of a CBR, a sidelink RSRP, or an LBT success rate.

In a thirty-eighth aspect, alone or in combination with one or more of the twenty-ninth aspect through the thirty-seventh aspect, starting performing the LBT procedure sequentially at each occasion of the plurality of feedback occasions includes determining a configuration of the plurality of feedback occasions including a number of feedback occasions in the plurality of feedback occasions.

In a thirty-ninth aspect, alone or in combination with the thirty-eighth aspect, starting performing the LBT procedure sequentially at each occasion of the plurality of feedback occasions includes extending an inactivity timer associated with receiving the sidelink transmission from the another UE to a duration covering the plurality of feedback occasions.

In a fortieth aspect, alone or in combination with one or more of the thirty-eighth aspect through the thirty-ninth aspect, starting performing the LBT procedure sequentially at each occasion of the plurality of feedback occasions includes starting performing the LBT procedure sequentially at each occasion of the plurality of feedback occasions over the number of feedback occasions in the plurality of feedback occasions while the inactivity timer is running.

In a forty-first aspect, alone or in combination with one or more of the thirty-eighth aspect through the fortieth aspect, starting performing the LBT procedure sequentially at each occasion of the plurality of feedback occasions includes starting the sidelink feedback timer after transmitting a feedback response.

In a forty-second aspect, alone or in combination with one or more of the thirty-eighth aspect through the forty-first aspect, starting the sidelink feedback timer causes the UE to stop the inactivity timer.

In a forty-third aspect, alone or in combination with one or more of the twenty-ninth aspect through the forty-second aspect, extending the inactivity timer includes starting the inactivity timer in response to receiving the sidelink transmission from the another UE.

In a forty-fourth aspect, alone or in combination with one or more of the twenty-ninth aspect through the forty-third aspect, performing the LBT procedure sequentially at each occasion of the plurality of feedback occasions includes determining the plurality of feedback occasions based on a duration for the LBT feedback timer, the duration for the LBT feedback timer covering the plurality of feedback occasions.

In a forty-fifth aspect, alone or in combination with the forty-fourth aspect, performing the LBT procedure sequentially at each occasion of the plurality of feedback occasions includes starting the LBT feedback timer.

In a forty-sixth aspect, alone or in combination with one or more of the forty-fourth aspect through the forty-fifth aspect, performing the LBT procedure sequentially at each occasion of the plurality of feedback occasions includes starting performing the LBT procedure sequentially at each occasion of the plurality of feedback occasions to transmit the feedback response to the another UE while the LBT feedback timer is running.

In a forty-seventh aspect, alone or in combination with one or more of the forty-fourth aspect through the forty-sixth aspect, performing the LBT procedure sequentially at each occasion of the plurality of feedback occasions includes starting the sidelink feedback timer after transmitting the feedback response.

In a forty-eighth aspect, alone or in combination with one or more of the forty-fourth aspect through the forty-seventh aspect, starting the sidelink feedback timer causes the UE to stop the LBT feedback timer.

In a forty-ninth aspect, alone or in combination with one or more of the twenty-ninth aspect through the forty-eighth aspect, starting performing the LBT procedure sequentially at each occasion of the plurality of feedback occasions to transmit the feedback response to the another UE while the LBT feedback timer is running includes starting the LBT feedback timer in response to one of receiving the sidelink transmission from the another UE, or before a first feedback occasion of the plurality of feedback occasions.

In a fiftieth aspect, alone or in combination with one or more of the twenty-ninth aspect through the forty-ninth aspect, the triggering condition associated with the feedback occasion of the plurality of feedback occasions includes one or more of transmitting the feedback response in the feedback occasion associated with the triggering condition, or reaching a last feedback occasion of the plurality of feedback occasions without an LBT success based, at least in part, on a type of the sidelink feedback.

In a fifty-first aspect, alone or in combination with one or more of the twenty-ninth aspect through the fiftieth aspect, transmitting the feedback response in the feedback occasion associated with the triggering condition includes obtaining LBT success for the feedback occasion associated with the triggering condition.

In a fifty-second aspect, alone or in combination with the fifty-first aspect, transmitting the feedback response in the feedback occasion associated with the triggering condition includes transmitting the feedback response in the feedback occasion associated with the triggering condition in response to the successful LBT procedure for the associated occasion.

In a fifty-third aspect, alone or in combination with one or more of the twenty-ninth aspect through the fifty-second aspect, the techniques of the twenty-ninth aspect include receiving a retransmission of the sidelink transmission from the another UE, the retransmission transmitted by the another UE in response to the UE reaching the last feedback occasion of the plurality of feedback occasions without receiving the feedback response from the based, at least in part, a type of the sidelink feedback.

In a fifty-fourth aspect, alone or in combination with one or more of the twenty-ninth aspect through the fifty-third aspect, receiving the retransmission of the sidelink transmission from the another UE includes starting a sidelink retransmission timer upon expiration of the sidelink feedback timer.

In a fifty-fifth aspect, alone or in combination with the fifty-fourth aspect, receiving the retransmission of the sidelink transmission from the another UE includes receiving the retransmission of the sidelink transmission from the another UE while the sidelink retransmission timer is running.

In a fifty-sixth aspect, alone or in combination with one or more of the twenty-ninth aspect through the fifty-fifth aspect, the techniques of the twenty-ninth aspect include receiving a retransmission of the sidelink transmission from the another UE when the feedback response transmitted to the another UE includes a NACK for the sidelink transmission.

In a fifty-seventh aspect, alone or in combination with the fifty-sixth aspect, the techniques of the twenty-ninth aspect include foregoing receiving a retransmission of the sidelink transmission from the another UE when the feedback response transmitted to the another UE includes an ACK for the sidelink transmission.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-9 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A user equipment (UE) comprising:
at least one processor; and
a memory coupled with the at least one processor and storing processor-readable code that, when executed by the at least one processor, is configured to perform operations including:
transmitting a sidelink transmission to another UE;
starting monitoring for a feedback response for the sidelink transmission from the another UE at each occasion of a plurality of feedback occasions covered by a sidelink feedback window;
detecting a triggering condition associated with a feedback occasion of the plurality of feedback occasions; and
in response to detecting the triggering condition associated with the feedback occasion of the plurality of feedback occasions:
starting a sidelink feedback timer; and
stopping monitoring for the feedback response at each occasion of the plurality of feedback occasions.

2. The UE of claim 1, wherein the operations of the starting monitoring for the feedback response for the sidelink transmission from the another UE includes determining a configuration of the plurality of feedback occasions based on one or more of:
a configuration based on one or more of quality of service (QoS) for sidelink communication or sidelink conditions, the configuration defining the plurality of feedback occasions covered by the sidelink feedback window for monitoring for the feedback response;
an activation of the plurality of feedback occasions covered by the sidelink feedback window for monitoring for the feedback response based on the one or more of QoS for sidelink communication or sidelink conditions; or
a dynamic signaling indicating the plurality of feedback occasions covered by the sidelink feedback window, wherein the dynamic signaling is based on one or more of QoS for a transmission block (TB) associated with the sidelink transmission or sidelink conditions.

3. The UE of claim 2, wherein the activation of the plurality of feedback occasions covered by the sidelink feedback window includes indicating the plurality of feedback occasions for the another UE via an activation indication transmitted from the UE to the another UE, the activation indication including a medium access control (MAC)-control element (CE).

4. The UE of claim 2, wherein the operations of the dynamic signaling indicating the plurality of feedback occasions includes:
determining the plurality of feedback occasions covered by the sidelink feedback window based on the one or more of QoS for the TB associated with the sidelink transmission or sidelink conditions, the sidelink conditions based, at least in part, on sidelink measurements;
selecting a resource pool including multiple feedback occasions meeting the one or more of QoS for the TB associated with the sidelink transmission or sidelink conditions;
selecting the plurality of feedback occasions covered by the sidelink feedback window from the selected resource pool; and
transmitting, to the another UE, an indication including one or more of: a number of feedback occasions in the plurality of feedback occasions covered by the sidelink feedback window or a duration of time covering the plurality of feedback occasions, wherein the indication is transmitted in sidelink control information concurrently transmitted with the sidelink transmission to the another UE.

5. The UE of claim 2, wherein the QoS for the TB associated with the sidelink transmission includes at least one QoS profile or direct interface (PC5) QoS indicator (5QI) that includes one or more of:
priority level of the sidelink transmission;
a reliability requirement for the sidelink transmission;
a data volume;
a maximum data rate; or
a packet delay budget (PDB) or remaining PDB.

6. The UE of claim 2, wherein the sidelink conditions are based, at least in part, on sidelink measurements including one or more of:
a channel busy rate (CBR);
a sidelink reference signal received power (RSRP); or
a listen-before-talk (LBT) success rate.

7. The UE of claim 1, wherein the operations of the starting monitoring for the feedback response for the sidelink transmission from the another UE includes:
determining the sidelink feedback window including a number of feedback occasions in the plurality of feedback occasions;
extending an inactivity timer associated with transmitting the sidelink transmission to the another UE to a duration configured to cover the number of feedback occasions after transmitting the sidelink transmission to the another UE;
starting monitoring for the feedback response for the sidelink transmission from the another UE over the number of feedback occasions in the plurality of feedback occasions while the inactivity timer is running; and
starting a sidelink feedback timer after receiving the feedback response, wherein starting the sidelink feedback timer causes the UE to stop the inactivity timer.

8. The UE of claim 7, wherein the operations of the extending the inactivity timer includes starting the inactivity timer in response to transmitting the sidelink transmission to the another UE.

9. The UE of claim 1, wherein the operations of the starting monitoring for the feedback response for the sidelink transmission from the another UE includes:
determining the plurality of feedback occasions based on a duration for a listen-before-talk (LBT) feedback timer, the duration for the LBT feedback timer covering the plurality of feedback occasions;
starting the LBT feedback timer;
starting monitoring for the feedback response for the sidelink transmission from the another UE while the LBT feedback timer is running; and
starting a sidelink feedback timer after receiving the feedback response, wherein starting the sidelink feedback timer causes the UE to stop the LBT feedback timer.

10. The UE of claim 9, wherein the operations of the starting the LBT feedback timer includes starting the LBT feedback timer in response to one of:
transmitting the sidelink transmission to the another UE; or
before a first feedback occasion of the plurality of feedback occasions.

11. The UE of claim 1, wherein the operations of the triggering condition associated with the feedback occasion of the plurality of feedback occasions includes one or more of:
receiving the feedback response at the feedback occasion associated with the triggering condition; or
reaching an end of the sidelink feedback window without receiving the feedback response from the another UE based, at least in part, on a type of the feedback response.

12. The UE of claim 11, wherein the feedback occasion associated with the triggering condition at which the feedback response is received by the UE includes a feedback occasion of the plurality of feedback occasions with a successful LBT procedure by the another UE.

13. The UE of claim 11, further comprising the operations of:
retransmitting the sidelink transmission to the another UE in response to reaching the end of the sidelink feedback window without receiving the feedback response from the another UE.

14. The UE of claim 13, wherein the operations of the retransmitting the sidelink transmission to the another UE includes:
starting a sidelink retransmission timer upon expiration of the sidelink feedback timer; and
retransmitting the sidelink transmission to the another UE while the sidelink retransmission timer is running.

15. The UE of claim 1, further comprising the operations of:
retransmitting the sidelink transmission to the another UE when the feedback response received from the another UE includes a negative acknowledgement (NACK) for the sidelink transmission; and
foregoing retransmitting the sidelink transmission to the another UE when the feedback response received from the another UE includes a positive acknowledgement (ACK) for the sidelink transmission.

16. A user equipment (UE) comprising:
at least one processor; and
a memory coupled with the at least one processor and storing processor-readable code that, when executed by the at least one processor, is configured to perform operations including:
receiving a sidelink transmission from another UE;
starting performing a listen-before-talk (LBT) procedure sequentially at each occasion of a plurality of feedback occasions covered by a sidelink feedback window to transmit a feedback response for the sidelink transmission;
detecting a triggering condition associated with a feedback occasion of the plurality of feedback occasions; and
in response to detecting the triggering condition associated with a feedback occasion of the plurality of feedback occasions:
starting a sidelink feedback timer; and
stopping performing the LBT procedure sequentially at each occasion of a plurality of feedback occasions.

17. The UE of claim 16, wherein the operations of the starting performing the LBT procedure sequentially includes determining a configuration of the plurality of feedback occasions based on one or more of:
a configuration based on one or more of quality of service (QoS) for sidelink communication or sidelink conditions, the configuration defining the plurality of feedback occasions for monitoring for the feedback response;
an activation of the plurality of feedback occasions for transmitting the feedback response based on the one or more of QoS for sidelink communication or sidelink conditions; or
a dynamic signaling indicating the configuration of the plurality of feedback occasions, wherein the dynamic signaling is based on one or more of QoS for a transmission block (TB) associated with the sidelink transmission or sidelink conditions.

18. The UE of claim 17, wherein the activation of the plurality of feedback occasions includes receiving an indication of the plurality of feedback occasions from the another UE via an activation indication, the activation indication including a medium access control (MAC)-control element (CE).

19. The UE of claim 17, wherein the operations of the dynamic signaling indicating the plurality of feedback occasions includes:
receiving, from the another UE, an indication of the plurality of feedback occasions, wherein the indication is received in sidelink control information concurrently transmitted with the sidelink transmission, wherein the plurality of feedback occasions is determined by the another UE based on one or more of QoS for a transmission block (TB) associated with the sidelink transmission or sidelink conditions, the indication of the plurality of feedback occasions including one or more of: a number of feedback occasions in the plurality of feedback occasions or a duration of time covering the plurality of feedback occasions, and wherein the plurality of feedback occasions is selected from a resource pool determined by the another UE to include multiple feedback occasions meeting the one or more of the QoS of the TB or the sidelink conditions, based, at least in part, on sidelink measurements.

20. The UE of claim 17, wherein the QoS for sidelink communication includes at least one QoS profile or direct interface (PC5) QoS indicator (5QI) that includes one or more of:
a priority level of the sidelink transmission;
a reliability requirement for the sidelink transmission;
a data volume;
a maximum data rate; or
a packet delay budget (PDB) or remaining PDB.

21. The UE of claim 17, wherein the sidelink conditions are based, at least in part, on sidelink measurements including one or more of:
a channel busy rate (CBR);
a sidelink reference signal received power (RSRP); or
a listen-before-talk (LBT) success rate.

22. The UE of claim 16, wherein the operations of the starting performing the LBT procedure sequentially includes:
determining a configuration of the plurality of feedback occasions including a number of feedback occasions in the plurality of feedback occasions;
extending an inactivity timer associated with receiving the sidelink transmission from the another UE to a duration covering the plurality of feedback occasions;
starting performing the LBT procedure sequentially at each occasion of the plurality of feedback occasions over the number of feedback occasions in the plurality of feedback occasions while the inactivity timer is running; and
starting a sidelink feedback timer after transmitting a feedback response, wherein starting the sidelink feedback timer causes the UE to stop the inactivity timer.

23. The UE of claim 22, wherein the operations of the extending the inactivity timer includes starting the inactivity timer in response to receiving the sidelink transmission from the another UE.

24. The UE of claim 16, wherein the operations of the starting performing the LBT procedure sequentially includes:
determining the plurality of feedback occasions based on a duration for an LBT feedback timer, the duration for the LBT feedback timer covering the plurality of feedback occasions;
starting the LBT feedback timer;
starting performing the LBT procedure sequentially at each occasion of the plurality of feedback occasions to transmit the feedback response to the another UE while the LBT feedback timer is running; and
starting a sidelink feedback timer after transmitting the feedback response, wherein starting the sidelink feedback timer causes the UE to stop the LBT feedback timer.

25. The UE of claim 24, wherein the operations of the starting performing the LBT procedure sequentially at each occasion of the plurality of feedback occasions to transmit the feedback response to the another UE while the LBT feedback timer is running includes starting the LBT feedback timer in response to one of:
receiving the sidelink transmission from the another UE; or
before a first feedback occasion of the plurality of feedback occasions.

26. The UE of claim 16, wherein the triggering condition associated with the feedback occasion of the plurality of feedback occasions includes the operations of one or more of:
transmitting the feedback response in the feedback occasion associated with the triggering condition; or
reaching a last feedback occasion of the plurality of feedback occasions without an LBT success based, at least in part, on a type of the feedback response.

27. The UE of claim 26, wherein the operations of the transmitting the feedback response in the feedback occasion associated with the triggering condition includes:
obtaining LBT success for the feedback occasion associated with the triggering condition; and
transmitting the feedback response in the feedback occasion associated with the triggering condition in response to the LBT success for the feedback occasion associated with the triggering condition.

28. The UE of claim 26, further comprising the operations of:
receiving a retransmission of the sidelink transmission from the another UE, the retransmission transmitted by the another UE in response to the another UE reaching the last feedback occasion of the plurality of feedback occasions without receiving the feedback response from the UE based, at least in part, a type of the feedback response.

29. The UE of claim 28, wherein the operations of the receiving the retransmission of the sidelink transmission from the another UE includes:
starting a sidelink retransmission timer upon expiration of the sidelink feedback timer; and
receiving the retransmission of the sidelink transmission from the another UE while the sidelink retransmission timer is running.

30. The UE of claim 16, further comprising the operations of:
receiving a retransmission of the sidelink transmission from the another UE when the feedback response transmitted to the another UE includes a negative acknowledgement (NACK) for the sidelink transmission; and
foregoing receiving a retransmission of the sidelink transmission from the another UE when the feedback response transmitted to the another UE includes a positive ACK (ACK) for the sidelink transmission.
